(19) United States
(12) Patent Application Publication
(10) Pub. No.: US 2026/0102694 A1
(43) Pub. Date: Apr. 16, 2026

(54) GAME CONTROLLER

(71) Applicant: Robert Michael Lyden, St. Paul, MN (US)

(72) Inventor: Kieran S. Lyden, Portland, OR (US)

(21) Appl. No.: 18/911,575

(22) Filed: Oct. 10, 2024

(51) Int. Cl. A63F 13/24; A63F 13/218; A63F 13/22

(52) U.S. Cl. CPC A63F 13/24; A63F 13/218; A63F 13/22

(57) ABSTRACT

A game controller for controlling the play of computerized games and other related control systems includes a plurality of bumper controls, trigger controls, and thumbstick controls which can be removed, replaced, and customized as desired by a user from the exterior side of the case. The sensitivity of at least some of these controls can be adjusted and their function can be programmed and customized.

### FIELD

The invention relates to game controllers for controlling the play of computerized games, more particularly, but not exclusively, the invention relates to ergonomics and a control system which can be programmed and customized.

### BACKGROUND OF THE INVENTION

Many different computers, gaming consoles, platforms, software, and game controllers are presently available to users for playing video games. For example, the Sony PlayStation corporate offices are located in San Mateo, California in the United States, and the company has a website https://www.playstation.com, and also makes the Playstation® 5 gaming console, and the DualShock® 1-4, Dual Sense®, and Dual Sense Edge® game controllers, and is associated with the following patents: U.S. Pat. No. 5,551,693 by Goto et al., U.S. Pat. No. 5,716,274, by Goto et al., U.S. Pat. No. 8,126,987 B2 by Chopra et al., U.S. Pat. No. 8,147,339 B2 by Perry, U.S. Pat. No. 8,229,359 B2 by Hino et al., U.S. Pat. No. 8,337,306 B2 by Larsen et al., U.S. Pat. No. 8,613,665 B2 by Goto et al., U.S. Pat. No. 8,672,767 B2 by Ogasawara et al., U.S. Pat. No. 8,769,594 B2 by Perlman et al., U.S. Pat. No. 8,949,869 B2 by Yoguchi, U.S. Pat. No. 9,003,461 B2 by Pearlman et al., U.S. Pat. No. 9,116,555 B2 by Nakayama et al., U.S. Pat. No. 9,174,122 B2 by Miyazaki, U.S. Pat. No. 9,202,508 B2 by Eto, U.S. Pat. No. 9,250,703 B2 by Hernandez-Abrego et al., U.S. Pat. No. 9,286,059 B2 by Hatakeyama, U.S. Pat. No. 9,345,966 B2 by Miura et al., U.S. Pat. No. 9,381,435 B2 by Nakayama et al., U.S. Pat. No. 9,474,975 B2 by Shimizu, U.S. Pat. No. 9,682,323, B2 by Imai et al., U.S. Pat. No. 9,690,392 B2 by Igarashi et al., U.S. Pat. No. 9,729,864 B2 by Stafford, U.S. Pat. No. 9,789,395 B2 by Igarashi et al., U.S. Pat. No. 9,847,104 B2 by Hirose et al., U.S. Pat. No. 9,861,898 B2 by Miura et al., U.S. Pat. No. 9,889,376 B2 by Imai et al., U.S. Pat. No. 9,922,184 B2 by Tonkunaga et al., U.S. Pat. No. 9,971,401 B2 by Stafford, U.S. Pat. No. 9,974,207 B2 by Tsuchida, U.S. Pat. No. 10,010,788 B2 by Huang, U.S. Pat. No. 10,028,007 B2 by Arriola et al., U.S. Pat. No. 10,120,438 B2 by Osman et al., U.S. Pat. No. 10,201,748 B2 by Nakayama et al, U.S. Pat. No. 10,251,292 B2 by Araki et al., U.S. Pat. No. 10,318,230 B2 by Watson et al., U.S. Pat. No. 10,477,771 B2 by Araki et al., U.S. Pat. No. 10,486,062 B2 by Ikenoue et al., U.S. Pat. No. 10,507,386 B2 by Igarashi et al., U.S. Pat. No. 10,516,724 B2 by Takaichi et al., U.S. at. No. 10,531,145 B2 by Morita et al., U.S. Pat. No. 10,532,284 by Stafford, U.S. Pat. No. 10,594,936 B2 by Nakamura et al., U.S. Pat. No, 10,596,464 B2 by Doucet et al., U.S. Pat. No. 10,603,576 B2 by Yoguchi, U.S. Pat. No. 10,610,778 B2 by Nakayama et al., U.S. Pat. No. 10,628,113 B2 by Ogiso et al., U.S. Pat. No. 10,712,575 B2 by Doucet et al., U.S. Pat. No. 10,750,631 B2 by Araki et al., U.S. Pat. No. 10,765,937 B2 by Igarashi et al., U.S. Pat. No. 10,850,192 B2 by Machida et al., U.S. Pat. No. 10,888,772 B2 by Ikenoue et al., U.S. Pat. No. 10,940,385 B2 by Black et al., U.S. Pat. No. 10,967,254 B2 by Black et al., U.S. Pat. No. 10,967,262 B2 by Imai et al., U.S. Pat. No. 10,974,148 B2 by Ikenoue et al., U.S. Pat. No. 11,033,816 B2 by Takaichi et al., U.S. Pat. No. 11,047,925 B2 by Black, U.S. Pat. No. 11,065,533 B2 by Gary et al., U.S. Pat. No. 11,093,114 B2 by Yamamoto et al., U.S. Pat. No. 11,103,774 B2 by Black et al., U.S. Pat. No. 11,154,778 B2 by Doucet et al., U.S. Pat. No. 11,173,393 B2 by Nakagawa et al., U.S. Pat. No. 11,429,187 B2 by Ishikawa et al., U.S. Pat. No. 11,511,185 B2 by Nakagawa et al., U.S. Pat. No. 11,654,353 B2 by Machida et al., U.S. 20100041480 A1 by Wong et al., U.S. 20130100021 A1 by Larsen et al., U.S. 20160232675 A1 by Ogasawara et al., U.S. 20200338445 A1 by Zhao et al., U.S. 20220305375 A1 by Morita et al., U.S. D572,254 S by Goto, U.S. D712408 by Sumii et al., U.S. D712484 by Sumii et al., U.S. D712971 by Huang, U.S. D712972 by Sumii et al., U.S. D712973 by Sumii et al., U.S. D715,296 S by Huang, U.S. D717876 by Sumii et al., U.S. D718390 by Sumii et al., U.S. D718818 by Sumii et al., U.S. D719953 by Nokuo et al., U.S. 727430 by Sumii et al., U.S. D733140 by Sumii et al., U.S. D764467 by Nokuo, U.S. D778909 by Nokuo, U.S. D839356 by Sumii, U.S. 932552 by Morisawa, U.S. 932553 by Morisawa, U.S. D933750 S by Kobayashi et al., U.S. D933751 S by Kobayashi et al., U.S. D934345 by Morimoto et al., U.S. D936149 by Morisawa, WO 2017150128 A1 by Machida et al., WO 2020235614 A1 by Morita et al., EP 3742260 A1 by Kawashima et al., KR 20220022121 A by Morita et al., KR 20220004662 A by Austin et al., KR 20170131237 A by Grant et al., CN 112334202 A by Masaho et al., and all of these patents and patent applications are hereby incorporated by reference herein. U.S. D715,296 S by Huang closely corresponds to the Sony® PS4 game controller.

The Microsoft Corporation based in Redmond, Washington has a website https://www.microsoft.com, and has made the Xbox® gaming console and the Xbox® Duke game controller, the Xbox 360® game console and controllers, and most recently the Xbox One® game console and controller and also the Xbox One Elite® game controller. Microsoft patents relating to mouse devices and game controllers include: U.S. Pat. No. 6,256,013 B1 by Siddiqui, U.S. Pat. No. 6,933,925 B1 by Gibbons et al., U.S. Pat. No. 7,345,674 B2 by McLoone et al., U.S. Pat. No. 7,656,389 B2 by Adan et al., U.S. Pat. No. 7,659,887 B2 by Larsen et al., U.S. Pat. No. 7,813,774 B2 by Perez-Noguera, U.S. Pat. No. 7,880,727 B2 by Abanami et al., U.S. Pat. No. 7,948,474 B2 by Chatterjee et al., U.S. Pat. No. 8,172,675 B2 by Migos et al., U.S. Pat. No. 8,409,002 B2 by Evans et al., U.S. Pat. No. 8,581,852 by Izadi et al., U.S. Pat. No. 8,648,822 B2 by Weiss, U.S. Pat. No. 8,665,244 by Large et al., U.S. Pat. No. 8,727,882 B2 by Lum et al., U.S. Pat. No. 8,754,855 B2 by Duncan et al., U.S. Pat. No. 8,884,907 B2 by Townsend et al., U.S. Pat. No. 8,913,019 B2 by Zhao et al., U.S. Pat. No. 8,933,912 B2 by Ambrus et al., U.S. Pat. No. 8,982,051 B2 by Rosenfeld et al., U.S. Pat. No. 9,029,721 B2 by Ikeda et al., U.S. Pat. No. 9,908,041 B2 by Kuzaski et al, U.S. Pat. No. 9,152,288 by Dietz, U.S. Pat. No. 9,227,141 B2 by Mays Ill et al., U.S. Pat. No. 9,251,701 B2 by Plagge et al., U.S. Pat. No. 9,372,588 B2 by Dietz et al., U.S. Pat. No. 9,098,117 B2 by Lutz et al., U.S. Pat. No. 9,152,288 B2 by Dietz, U.S. Pat. No. 9,174,124 B2 by Hammontree et al., U.S. Pat. No. 9,223,471 B2 by Buxton et al., U.S. Pat. No. 9,250,753 B2 by Westhues et al., U.S. Pat. No. 9,285,907 B2 by Weiss et al., U.S. Pat. No. 9,335,900 B2 by Weiss et al., U.S. Pat. No. 9,354,804 B2 by Berkes et al., U.S. Pat. No. 9,377,646 B2 by Westhues et al., U.S. Pat. No. 9,436,338 B2 by Keller et al., U.S. Pat. No. 9,501,218 B2 by Hwang et al, and U.S. Pat. No. 9,519,419 B2 by Hickley et al., U.S. Pat. No. 9,764,230 B2 by Gassoway et al., U.S. Pat. No. 10,124,249 B2 by Schmitz et al., U.S. Pat. No. 10,348,108 B2 by Hodges et al., U.S. Pat. No. 10,427,035 B2 by Schmitz et al., U.S. Pat. No. 10,475,606 B2 by Schmitz, U.S. Pat. No. 10,835,812 B2 Gassoway et al., U.S. Pat. No. 11,794,098 B2 by Schmitz et al., U.S. D709,882 S by Morris et al., U.S. D772,988 S by Kujawski et al., U.S. D847265 by Chatterjee et al., U.S. D847903 by Chatterjee et al., U.S. D872184 by Chatterjee et al., U.S. D909487 by Whitaker et al., U.S. D917622 by Hsue et al., U.S. D928234 by Hsu et al., U.S. D934344 by Hsu et al., U.S. D936146 by Hsu et al., U.S. D963751 by Chatterjee et al., U.S. Pat. No. 963,752 by Chatterjee et al., U.S. D1012197 by Chatterjee et al., U.S. 20070078002 A1 by Evans et al., U.S. 20090146958 A1 by Ikeda et al., U.S. 20100222146 A1 by Evans et al., U.S. 20100178984 A1 by Lum et al., U.S. 20130053146 A1 by Ikeda et al., U.S. 20160317921 A1 by Schmitz et al., U.S. 20160317925 A1 by Miller, U.S. 20160361639 A1 by Schmitz et al., U.S. 20180345134 A1 by Schmitz et al., and WO 1016178787 A1 by Schmitz et al., and all of these patents and patent applications are hereby incorporated by reference herein., U.S. D709,882 S by Morris et al. closely corresponds to the Xbox One® game controller, and U.S. D772,988 S by Kujawski et al. closely corresponds to the Xbox One Elite® game controller.

Scuf Gaming International LLC also known as Scuf® was founded in 2011 by Duncan Ironmonger and originally based in Shepshed, England, but was later acquired by Corsair Gaming, Inc. of Milpitas, California, and has corporate offices in Suwanee, Georgia, a website https://scufgaming.com, and commercialized game controllers including paddle controls such as the Envision Pro, Impact, Infinity, Instinct Pro, and Reflex, and is associated with numerous patents and patent applications including: U.S. Pat. No. 8,480,491 B2 by Burgess et al., U.S. Pat. No. 8,641,525 B2 by Burgess et al., U.S. Pat. No. 9,089,770 B2 by Burgess et al., U.S. Pat. No. 9,289,688 B2 by Burgess et al., U.S. Pat. No. 9,308,450 B2 by Burgess et al., U.S. Pat. No. 9,308,451 B2 by Burgess et al., U.S. Pat. No. 9,352,229 B2 by Burgess et al., U.S. Pat. No. 9,492,744 B2 by Burgess et al., U.S. Pat. No. 9,533,219 B2 by Burgess et al., U.S. Pat. No. 9,550,116 B2 by Burgess et al., U.S. Pat. No. 9,707,479 B2 by Burgess et al., U.S. Pat. No. 9,878,238 B2 by Burgess et al, U.S. Pat. No. 10,029,175 B2 by Burgess et al., U.S. Pat. No. 10,188,940 B2 by Burgess et al, U.S. Pat. No. 10,220,308 B2 by Ironmonger et al., U.S. Pat. No. 10,258,877 B2 by Burgess et al., U.S. Pat. No. 10,279,250 B2 by Burgess et al., U.S. Pat. No. 10,286,305 B2 by Burgess et al., U.S. Pat. No. 10,350,490 B2 by Ironmonger et al., U.S. Pat. No. 10,576,386 B2 by Ironmonger et al., U.S. Pat. No. 11,806,613 B2 by Burgess et al., U.S. D667892 by Burgess et al., U.S. D721139 by Burgess et al., U.S. D728030 by Burgess et al., U.S. D730451 by Burgess et al., U.S. D733802 by Burgess et al., U.S. D748734 by Burgess et al., U.S. D777260 by Burgess et al., U.S. D780180 by Ironmonger et al., U.S. D780759 by Ironmonger et al., U.S. D780760 by Ironmonger et al., U.S. D794027 by Ironmonger et al., U.S. D983269 by Daddar et al., and published U.S. patent applications U.S. 20160082349 A1 by Burgess et al., U.S. 20160296837 A1 by Burgess et al., U.S. 20160346682 A1 by Burgess et al., U.S. 20230233948 A1 by Ironmonger et al., U.S. 20230285849 A1 by Burgess et al., all of these patents and patent applications are hereby incorporated by reference herein. The Microsoft Corporation licensed some of the patents of Scuf Gaming International LLC and/or Ironburg Inventions Ltd. to commercialize the Microsoft Xbox One Elite® game controller.

Performance Designed Products (PDP) based in Burbank, California was recently purchased by the company Turtle Beach of San Diego, California, and has a website https://www.pdp.com, and makes the Victrix Pro BFG game controller. Performance Designed Products has patents for game controllers which include: U.S. Pat. No. 8,926,432 B2 by Roberts, U.S. Pat. No. 9,804,691 B1 by Strahle et al., U.S. Pat. No. 9,811,172 B1 by Strahle et al., U.S. Pat. No. 9,971,420 B2 by Strahle et al., U.S. Pat. No. 10,149,033 by Karacal, U.S. Pat. No. 10,042,435 B2 by Strahle et al., U.S. Pat. No. 10,061,397 B2 by Strahle et al., U.S. Pat. No. 10,143,921 B1 by Strahle et al., U.S. Pat. No. 10,149,033 B2 by Karacal, U.S. Pat. No. 10,159,896 B2 by Strahle et al., U.S. Pat. No. 10,183,218 B1 by Strahle et al., U.S. Pat. No. 10,187,715 B2 by Karacal, U.S. 10,191,714 B2 by Wiggemans et al., U.S. Pat. No. 10,272,327 B2 by Strahle et al., U.S. Pat. No. 10,335,674 B1 by Trenado et al., U.S. Pat. No. 10,427,037 B2 by Strahle et al., U.S. Pat. No. 10,561,937 B2 by Strahle et al., U.S. Pat. No. 10,569,162 B2 by Strahle, U.S. Pat. No. 10,737,171 B2 by Strahle et al., U.S. Pat. No. 10,758,814 2 by Trenado et. al., U.S. Pat. No. 10,874,938 B2 by Strahle et al., U.S. Pat. No. 10,942,584 B2 by Strahle et al., U.S. Pat. No. 11,298,610 B2 by Orion et al., U.S. 20090233710 A1 by Roberts, U.S. D810,202 S by Foster et al., U.S. D833,389 S by Dunham et al., U.S. D835,036 S by Dunham et al., U.S. D845395 by Strahle et al., U.S. D849147 by Strahle et al., U.S. D850,447S by Fulghum et al., U.S. D853384 by Fulghum et al., U.S. D864302 by Strahle et al., U.S. D866664 by Stahle et al., U.S. D867,458 by Strahle et al., U.S. D890,846 by Fulghum et al., and all of these patents and patent applications are hereby incorporated by reference herein.

Nintendo® based in Kyoto, Japan has a website https://www.nintendo.com, and has made the Nintendo Entertainment System®, the Super Nintendo Entertainment System®, Nintendo 64®, Nintendo GameCube®, and the Wii® and the Wii U® gaming consoles and each console's respective controllers. Nintendo® patents for game controllers include: U.S. Pat. No. 6,489,946 B1 by Takeda et al., U.S. Pat. No. 8,715,080 B2 by Yasuda et al., U.S. Pat. No. 8,749,489 B2 by Ito et al., U.S. Pat. No. 9,517,407 B2 by Yasuda et al., U.S. Pat. No. 9,526,986 B2 by Tanaka et al., U.S. Pat. No. 9,526,987 B2 by Horita et al., U.S. 20160232675 A1, and all of these patents and patent applications are hereby incorporated by reference herein.

Razer, Inc. based in Irvine, California and Singapore and has a website https://www.razer.com, and makes the Wolverine V3 Pro game controller, and U.S. Patents assigned to Razer include: U.S. Pat. No. 9,128,539 B2 by Ng, U.S. 20100245249 A1 by Ng, AU 2012391086 A by Uy, et al., CN 112714665 A by Guerrero et al., U.S. D881281 by Tong, U.S. D888832 by Tong, U.S. D890,263 by Tong, and U.S. D932554 by Tong, and all of these patents and patent applications are hereby incorporated by reference herein.

NACON® is based in Lesquin, France and has a website https://www.nacongaming.com, and makes the Revolution 5 Pro and Revolution X Pro Controllers, and will be also releasing the Revolution X Unlimited game controller in the future.

Valve Corporation is based in Bellevue, Washington, and has a website https://www.valvesoftware.com, and is now a video game developer, publisher, and digital distribution company which has the Steam platform, but at one time made game controllers. Valve patents for game controllers include: U.S. Pat. No. 10,328,344 B2 by Bellinghausen et al., U.S. Pat. No. 10,406,431 B2 by Campbell et al., U.S. Pat. No. 10,639,543 B2 by Campbell et al., U.S. Pat. No. 10,722,786 B2 by Bellinghausen et al., U.S. Pat. No. 11,511,186 B2 by VanWyk et al., U.S. 20150105152 by Bellinghausen et al., U.S. 20190291000 A1 by Campbell et al., and U.S. 202000353349 A1 by Palmer et al., and all of these patents and patent applications are hereby incorporated by reference herein.

Panda Hardware LLC was a game controller startup as shown in the website https://pandagn.com, and was associated with U.S 20230071216 A1 by Samperi and U.S. 20230133332 A1 by Samperi, and all of these patents and patent applications are hereby incorporated by reference herein.

Anascape, Ltd. of Carson City, Nevada has been associated with U.S. Pat. No. 5,999,084 by Armstrong granted Dec. 7, 1999, U.S. Pat. No. 6,102,802 by Armstrong granted Aug. 15, 2000, U.S. Pat. No. 6,135,886 by Armstrong granted Oct. 24, 2000, U.S. Pat. No. 6,208,271 B1 by Armstrong granted Mar. 27, 2001, U.S. Pat. No. 6,222,525 B1 by Armstrong granted Apr. 24, 2001, U.S. Pat. No. 6,343,991 B1 by Armstrong granted Feb. 5, 2002, U.S. Pat. No. 6,344,791 B1 by Armstrong granted Feb. 5, 2002, U.S. Pat. No. 6,347,997 B1 by Armstrong granted Feb. 19, 2002, U.S. Pat. No. 6,351,205 B1 by Armstrong granted Feb. 26, 2002, U.S. Pat. No. 6,400,303 B2 by Armstrong granted Jun. 4, 2002, U.S. Pat. No. 6,563,415 B2 by Armstrong granted May 13, 2003, and U.S. Pat. No. 6,906,700 B1 granted Jun. 14, 2005, WO 200068930 A1 by Armstrong, and all of these patents and patent applications are hereby incorporated by reference herein.

There are also many other designers and/or manufacturers of game controllers which are compatible with different gaming consoles and systems. Other patents for switches and/or game controllers include: U.S. Pat. No. 3,806,471 by Mitchell, U.S. Pat. No. 4,315,238 by Eventoff, U.S. Pat. No. 4,508,942 by Inaba, U.S. Pat. No. 4,739,128 by Grisham, U.S. Pat. No. 5,984,548 by Willner et al., U.S. Pat. No. 6,019,680 by Cheng, U.S. Pat. No. 6,193,609 B1 by D'Archard Van Enschut, U.S. Pat. No. 6,313,826 B1 by Schrum et al., U.S. Pat. No. 6,512,511 B2 by Willner et al., U.S. Pat. No. 6,760,013 by Willner et al, U.S. Pat. No. 7,205,980 B2 by Maroun, U.S. Pat. No. 7,939,774 B2 by Corcoran et al., U.S. Pat. No. 7,995,035 B2 by Wu, U.S. Pat. No. 8,496,528 B2 by Muramatsu, U.S. Pat. No. 8,547,334 B2 by Min-Liang et al., U.S. Pat. No. 9,005,025 B2 by Joynes et al. assigned to Wikipad, Inc., U.S. Pat. No. 9,005,025 by Joynes et al., U.S. Pat. No. 9,504,911 B2 by Hackney assigned to Cinch Gaming Equipment LLC, U.S. Pat. No. 10,471,345 by Fuchs et al., U.S. Pat. No. 10,671,184 by Kim, U.S. Pat. No. 10,874,936 B2 by Higgins, U.S. Pat. No. 11,524,227 B2 by Lee, U.S. 20050083297 A1 by Duncan, U.S. 20060025217 A1 by Hussaini et al., U.S. 20060040740 A1 by Didato, U.S. 20120007822 A1 by Luo, U.S. 20120034978 by Lim, U.S. 20130012319 A1 by Negroponte et al., U.S. 20130215081 A1 by Levin et al., U.S. 20140078086 A1 by Bledsoe et al., U.S. 20170189800 by Crain, CN 112334202 A, WO 2023178564 A1 by Huang et al., WO 2007040499 by Hussaini et al., JP 3217436 U by Xiecheng et al., JP 6730918 B2 by Muramatsu et al, JP 2018010639 A by Grant, GB 2419174 A by Hussani et al., U.S. D608784 by Biheller, assigned to Dreamgear LLC, U.S. D885387 by Hu, U.S. D868898 by Fei, U.S. D906430 by Feng, D907119 by Zhou, U.S. D908800 by Tang, U.S. U.S. D912734 by Yang, U.S. D921116 by Zhou, U.S. D924977 by Saito, U.S. D926887 by Yang, U.S. D940244 by Zhou, U.S. D947948 by Ma et al., U.S. D963650 by Qin, U.S. D976325 by Fuchs et al., U.S. D1002732 by Young et al., U.S. D1007591 by Wu, and all of these patents and patent applications are hereby incorporated by reference herein.

### SUMMARY

A first aspect of the present invention provides a hand-held game controller comprising: a case comprising a top side, a bottom side, a front side, a rear side, a left side, a left shoulder portion, a left handle portion, a right side, a right shoulder portion, a right handle portion, and a middle portion; comprising at least two controls on each of the left shoulder portion and the right shoulder portion.

Optionally, the at least two controls comprise electrically resistive pressure sensitive touch controls.

Optionally, the electrically resistive pressure sensitive touch controls can each be configured to initiate a command with an applied force in the range between 10-50 grams when measured pursuant to ASTM 1578.

Optionally, the electrically resistive pressure sensitive touch controls can each be configured to initiate a command with an applied force in the range between 15-30 grams when measured pursuant to ASTM 1578.

Optionally, the at least two controls comprise capacitive controls.

Optionally, the capacitive controls can be configured to initiate a command when the distance of a user's finger is in the range between and including direct contact of the finger of the user, that is, 0 distance, and a distance of the finger equal to or less than ¼ inch or 6.35 mm from the capacitive controls.

Optionally, the capacitive controls can be configured to initiate a command when the distance of a user's finger is in the range between and including direct contact of the finger of the user, that is, 0 distance, and a distance of the finger equal to or less than ⅛ths inch or 3.175 mm from the capacitive controls.

Optionally, the at least two controls comprise at least one electrically resistive pressure sensitive touch control and at least one capacitive control.

Optionally, the at least one electrically resistive pressure sensitive touch control can be configured to initiate a command with an applied force in the range between 10-50 grams when measured pursuant to ASTM 1578.

Optionally, the at least one electrically resistive pressure sensitive touch control can be configured to initiate a command with an applied force in the range between 15-30 grams when measured pursuant to ASTM 1578.

Optionally, the middle portion comprises at least one touch pad control on the top side.

Optionally, the middle portion comprises at least two controls on the bottom side.

Optionally, the at least two controls on the bottom side comprise paddle controls.

Optionally, the at least two controls on the bottom side comprise push-button key controls.

Optionally, the at least two controls on the bottom side comprise at least one touch pad control.

Optionally, the at least one touch pad control distinguishes the touch of multiple independent fingers.

Optionally, the left handle portion and the right handle portion each comprise at least one customizable and removable grip portion.

Optionally, the game controller comprises at least one control comprising a normally closed switch which connects a first closed electrical circuit to ground in the resting position, but which removes the connection to ground and permits electrical energy to flow in a second closed electric circuit when the control is actuated by a user.

Optionally, the game controller comprises at least two thumbstick controls.

Optionally, the game controller comprises two thumbstick controls located on the top side of the case and arranged in a symmetrical configuration relative to the left handle portion, the middle portion, and the right handle portion.

Optionally, the game controller comprises two thumbstick controls located on the top side of the case and arranged in an asymmetrical configuration relative to the left handle portion, the middle portion, and the right handle portion.

Optionally, the thumbsticks further comprise a push button control.

Optionally, the case comprises a receptacle for receiving and a retaining ring for securing at least one removably attachable gate comprising a geometric shape for customizing the play of at least one control.

Optionally, the gate comprises a geometric shape selected from the group of geometric shapes consisting of: a circular shape, an octagonal shape, a square shape, and a diamond shape.

Optionally, the game controller further comprises a plurality of other additional individual controls selected from the group consisting of: an on/off control, a keyboard control, a master control, a menu control, a control remapping control, a camera control, a chat control, at least one shift control, at least one bumper control, at least one trigger control, at least one hair trigger lock control, at least one sensitivity control, at least one cross-shaped directional control, at least one paddle control, at least one push button control, at least one touch screen control, at least one touch pad control, at least one joystick control, at least one thumbstick control, and, at least one action button control.

Optionally, the game controller comprising means for communication with at least one of a game console and a game platform, the means for communication selected from the group consisting of: a wire cable connection, a fiber optic cable connection, and a wireless connection.

A second aspect of the present invention provides a hand-held game controller comprising: a case comprising a top side, a bottom side, a front side, a rear side, a left side, a left shoulder portion, a left handle portion, a right side, a right shoulder portion, a right handle portion, and a middle portion; the left handle portion comprising a first customizable and removable grip portion on the left side, and the right handle portion comprising a second customizable and removable grip portion on the right side for accommodating different users having small, medial, and large hands.

A third aspect of the present invention provides a hand-held game controller comprising: a case comprising a top side, a bottom side, a front side, a rear side, a left side, a left shoulder portion, a left handle portion, a right side, a right shoulder portion, a right handle portion, and a middle portion; comprising a removable gate comprising a geometric shape for customizing the play of at least one control.

Optionally, the gate comprises a geometric shape selected from the group consisting of: a circular shape, an octagonal shape, a square shape, and a diamond shape.

A fourth aspect of the present invention provides a hand-held game controller comprising: a case comprising a top side, a bottom side, a front side, a rear side, a left side, a left shoulder portion, a left handle portion, a right side, a right shoulder portion, a right handle portion, and a middle portion; and at least one control comprising a normally closed switch which connects a first closed electrical circuit to ground in the resting position, but which breaks the connection to the circuit to ground and permits electrical energy to flow in the second closed electric circuit when the control is actuated by a user.

A fifth aspect of the present invention provides a hand-held game controller comprising a plurality of controls, wherein a majority of the plurality of controls are touch controls.

A sixth aspect of the present invention provides a hand-held game controller comprising a plurality of controls, wherein a majority of the plurality of controls are capacitive controls.

Optionally, the game controller comprises a case comprising a top side, a bottom side, a front side, a rear side, a left side, a left shoulder portion, a left handle portion, a right side, a right shoulder portion, a right handle portion, and a middle portion.

Optionally, the game controller comprises a plurality of other additional controls selected from the group consisting of: an on/off control, a keyboard control, a master control, a menu control, a control remapping control, a camera control, a chat control, at least one shift control, at least one bumper control, at least one trigger control, at least one hair trigger lock control, at least one sensitivity control, at least one cross-shaped directional control, at least one paddle control, at least one push button control, at least one touch screen control, at least one touch pad control, at least one joystick control, at least one thumbstick control, and, at least one action button control.

A seventh aspect of the present invention provides a game controller comprising: a case comprising an interior side, and an exterior side, the exterior side comprising at least one thumbstick control receptacle; and, at least one thumbstick control configured to be removed from and placed in the thumbstick control receptacle.

Optionally, the game controller further comprises at least one trigger control.

Optionally, the at least one trigger control comprises at least one electrically resistive pressure sensitive touch control and/or at least one capacitive control.

Optionally, the game controller further comprises at least one bumper control.

Optionally, the at least one bumper control comprises at least one electrically resistive pressure sensitive touch control and/or at least one capacitive control.

Optionally, the exterior side further comprises at least one trigger control receptacle, and the at least one trigger control is configured to be removed from and replaced in the at least one trigger control receptacle.

Optionally, the exterior side further comprises at least one bumper control receptacle, and the at least one bumper control is configured to be removed from and replaced in the at least one bumper control receptacle.

Optionally, the at least one trigger control comprises at least one electrically resistive pressure sensitive touch control, and a range of force required to actuate the at least one electrically resistive pressure sensitive touch control is in the range between 10-50 grams when measured pursuant to ASTM 1578.

Optionally, the at least one bumper control comprises at least one electrically resistive pressure sensitive touch control, and a range of force required to actuate the at least one electrically resistive pressure sensitive touch control is in the range between 10-50 grams when measured pursuant to ASTM 1578.

Optionally, the game controller further comprises at least one sensitivity control for selectively adjusting the sensitivity of the at least one trigger control.

Optionally, the game controller further comprises at least one sensitivity control for selectively adjusting the sensitivity of the at least one bumper control.

Optionally, the at least one thumbstick control further comprises a push button control and/or a sensitivity control.

Optionally, the case and/or the at least one thumbstick control is configured to receive at least one removable gate configured to be positioned about the at least one thumbstick control, and the at least one removable gate is selected from a plurality of removable gates each comprising an opening having a different geometric shape selected from the group consisting of a circular shape, an octagonal shape, a square shape, and a diamond shape.

Optionally, the game controller comprises a plurality of other additional controls selected from the group consisting of: an on/off control, a keyboard control, a master control, a menu control, a control remapping control, a camera control, a back control, a chat control, at least one shift control, at least one hair trigger lock control, at least one sensitivity control, at least one cross-shaped directional control, at least one paddle control, at least one push button control, at least one touch screen control, at least one touch pad control, and, at least one action button control.

Optionally, the exterior side comprises a top side, a bottom side, a front side, a rear side, a left side, a left shoulder portion, a left handle portion, a right side, a right shoulder portion, a right handle portion, and a middle portion.

Optionally, the at least one trigger control comprises a capacitive control and a distance required to actuate the at least one trigger control is in the range between 0 and ¼ inch from the at least one trigger control.

Optionally, the at least one bumper control comprises a capacitive control and a distance required to actuate the at least one bumper control is in the range between 0 and ¼ inch from the at least one bumper control.

Optionally, the at least one thumbstick receptacle and/or the at least one thumbstick control comprise at least one of a tongue, a groove, an 0 ring groove, an 0 ring, a magnet or magnetic metal, and a snap fit structure.

An eight aspect of the present invention provides a game controller comprising: a case comprising an interior side and an exterior side; the exterior side comprising at least one trigger control receptacle, at least one bumper control receptacle, and at least one thumbstick control receptacle; at least one trigger control configured to be removed from and replaced in the at least one trigger control receptacle; at least one bumper control configured to be removed from and replaced in the at least one bumper control receptacle; and, at least one thumbstick control being configured to be removed from and replaced in the at least one thumbstick control receptacle.

An ninth aspect of the present invention provides a game controller comprising: a case comprising an interior side and an exterior side; the exterior side comprising at least one trigger control receptacle, at least one bumper control receptacle, at least one thumbstick control receptacle, and at least one removable grip receptacle; the at least one trigger control configured to be removed from and replaced in the at least one trigger control receptacle, the least one trigger control comprising at least one conventional mechanical actuator or lever switch control, and/or at least one electrically resistive pressure sensitive touch control, and/or at least one capacitive control; at least one bumper control configured to be removed from and replaced in the at least one bumper control receptacle, the at least one bumper control comprising at least one conventional mechanical actuator or lever switch control, and/or at least one electrically resistive pressure sensitive touch control, and/or at least one capacitive control; at least one thumbstick control being configured to be removed from and replaced in the at least one thumbstick control receptacle on the exterior side of the case; at least one sensitivity control for selectively adjusting the sensitivity of at least one of the at least one bumper control, and/or the at least one trigger control, and/or the at least one thumbstick control; at least one removable gate configured to be positioned about the at least one thumbstick control selected from a plurality of removable gates each comprising an opening having a different geometric shape selected from the group consisting of a circular shape, an octagonal shape, a square shape, and a diamond shape; and, at least one removable grip configured to be removed from and replaced in the at least one removable grip receptacle.

### BRIEF DESCRIPTION OF THE DRAWINGS

Aspects of the invention are described in detail below with reference to the attached drawing figures, wherein:

FIG. 1 is a top view of a game controller according to one embodiment having asymmetrical placement of thumbstick controls.

FIG. 2 is a bottom view of the game controller shown in FIG. 1 showing paddle controls on the left and right handle portions of the game controller.

FIG. 3 is a front view of the game controller shown in FIG. 1.

FIG. 4 is a top view of a game controller according to one embodiment generally similar to that shown in FIG. 1, but having a symmetrical placement of thumbstick controls on the top side.

FIG. 5 is a bottom view of a game controller according to one embodiment similar to that shown in FIG. 2, but including two paddle controls on each of the left and right handle portions of the game controller.

FIG. 6 is a bottom view of a game controller according to one embodiment similar to that shown in FIG. 5, but further including two paddle controls on the middle portion of the game controller.

FIG. 7 is a top view of a game controller according to one embodiment having symmetrical placement of thumbstick controls on the top side.

FIG. 8 is a bottom view of the game controller shown in FIG. 7 showing paddle controls on the left and right handle portions of the game controller.

FIG. 9 is a front view of the game controller shown in FIG. 7.

FIG. 10 is a bottom view of a game controller according to one embodiment similar to that shown in FIG. 8, but including two paddle controls on each of the left and right handle portions of the game controller.

FIG. 11 is a bottom view of a game controller according to one embodiment similar to that shown in FIG. 10, but further including two paddle controls in the middle portion of the game controller.

FIG. 12 is a cross-section view of a paddle control and push-button control switch according to one embodiment on the left handle portion of a game controller which is generally similar to that shown in FIG. 8, taken along line 44. The paddle control design and position of the push button control switch below is such that depressing the paddle control causes the control switch to be actuated.

FIG. 13 is a cross-sectional view of a portion of the case of an alternative embodiment of a game controller and a push button control switch which can be activated with a paddle control by a user which is generally similar to that shown in FIG. 8, taken along line 44. The paddle control design and sideways position of the push button control switch is such that depressing the paddle control causes the control switch to be actuated.

FIG. 14 is a schematic view which relates to a portion of the case of an alternative game controller and a control switch with parts broken away which can be activated with a paddle control by a user. The paddle control includes an electrically conductive contact which in the normally resting and closed position connects to a first closed ground circuit and also a second closed circuit, but when the paddle control is actuated the first closed circuit to ground is broken and electrical power can flow in the second closed circuit.

FIG. 15 is a cross-sectional view of a portion of the case of an alternative game controller and a control switch which can be activated with a paddle control by a user which is generally similar to that shown in FIG. 8, taken along line 44. The paddle control design and sideways position of the control switch spring and contact is such that depressing the paddle control causes the control switch to be actuated.

FIG. 16 is a cross-sectional view of a portion of the case of an alternative game controller and a control switch which can be activated with a paddle control by a user which is generally similar to that shown in FIG. 8, taken along line 44. The paddle control design and approximately vertical position of the control switch spring and contact is such that depressing the paddle control causes the control switch to be actuated.

FIG. 17 is a cross-sectional view of a portion of the case of an alternative game controller and a control switch which can be activated with a paddle control by a user which is generally similar to that shown in FIG. 8, taken along line 44. The paddle control design and external position of the control switch spring and contact is such that depressing the paddle control causes the control switch to be actuated.

FIG. 18 is a side view of one end of an alternative paddle control showing an opening for receiving a removable retaining pin.

FIG. 19 is a bottom view of one end of an alternative paddle control showing an integral axle for mating with a female receptacle.

FIG. 20 is a side view of one end of an alternative paddle control showing a semi-circular female receptacle for mating with a pin fixed in the case or a removable retaining pin as shown in FIG. 18.

FIG. 21 is a top view of one end of an alternative paddle control including an opening for receiving a screw.

FIG. 22 is a cross sectional view of a portion of the case of an alternative embodiment of a game controller showing an alternative paddle control including a magnet 50 for mating with a second magnet secured to the case of the game controller which is generally similar to that shown in FIG. 8, taken along line 44.

FIG. 23 is a top view of a game controller similar to that shown in FIG. 1, showing alternative retaining rings and/or gates having different geometric shapes which can be used to customize the play of thumbstick controls.

FIG. 24 is a top view of a game controller similar to that shown in FIG. 1 showing different customizable and selectively removable ergonomic grips for accommodating users having small, medium, and large hand sizes.

FIG. 25 is a side view of the right side of the game controller shown in FIG. 7 showing different customizable and selectively removable ergonomic grips for accommodating users having small, medium, and large hand sizes.

FIG. 26 is a top view of a resilient cover for use with a game controller similar to that shown in FIG. 1 which can be provided in small, medium, and large hand sizes.

FIG. 27 is bottom view of a game controller according to one embodiment which can include controls and features resembling those shown on the top side and front side of the alternate embodiments shown in FIG. 1, but which include two keys for actuating switches generally similar to those used on mouse devices on each handle, and also two keys in the middle portion of the game controller.

FIG. 28 is bottom view of a game controller according to one embodiment which can include controls and features resembling those shown on the top side and front side of the alternate embodiments shown in FIG. 7, but which includes two keys for actuating switches generally similar to those used on mouse devices on each handle portion, and also two keys in the middle portion of the game controller.

FIG. 29 is bottom view of an alternative embodiment of a game controller which can include controls and features resembling the those shown on the top side and front side of the alternate embodiments shown in FIG. 1, but which includes a plurality of touch pads on each of the left handle portion and right handle portion and also in the middle portion for actuating control of game play.

FIG. 30 is bottom view of an alternative embodiment of a game controller which can include controls and features resembling the those shown on the top side and front side of the alternate embodiments shown in FIG. 7, but which includes a plurality of touch pads on each of the left handle portion and right handle portion and also in the middle portion for actuating control of game play.

FIG. 31 is a bottom view of a game controller according to one embodiment which shows a single touch pad on the left handle portion, and a single touch pad on the right handle portion.

FIG. 32 is a bottom view of a game controller according to one embodiment which shows a single touch pad on the left handle portion, and a single touch pad on the right handle portion.

FIG. 33 is a front view of a game controller according to one embodiment including two touch pads on the right shoulder portion, and two touch pads on the left shoulder portion.

FIG. 34 is a front view of a game controller according to one embodiment including two touch pads on the right shoulder portion, and two touch pads on the left shoulder portion.

FIG. 35 is a front view of a game controller according to one embodiment generally similar to that shown in FIG. 33, but including a single touch pad on the right shoulder portion, and a single touch pad on the left shoulder portion for actuating control of game play.

FIG. 36 is a front view of a game controller according to one embodiment generally similar to that shown in FIG. 34, but including a single touch pad on the right shoulder portion, and a single touch pad on the left shoulder portion for actuating control of game play.

FIG. 37 is a top view of a game controller according to one embodiment including at least two touch pads and a touch screen on the top side of the game controller.

FIG. 38 is a top view of a game controller according to one embodiment including at least two touch pads and a touch screen on the top side of the game controller.

FIG. 39 is a top view a game controller according to one embodiment including at least two touch pads and a touch screen on the top side of the game controller as shown in FIG. 37, but which further includes a single touch pad on the on the right shoulder portion, and a single touch pad on the left shoulder portion as shown in FIG. 35, and also on the bottom side a single touch pad on the right handle portion, and a single touch pad on the left handle portion which have multi-finger detection and control capability and can be mapped and selected for desired control functions and operations.

FIG. 40 is a top view of a game controller according to one embodiment including at least two touch pads and a touch screen on the top side of the game controller as shown in FIG. 37, and at least two touch pads on the on the right shoulder portion, and at least two touch pads on the left shoulder portion as shown in FIG. 33, and on the bottom side also includes at least two of touch pads on the right handle portion and at least two of touch pads on the left handle portion for actuating control of game play as shown in FIG. 29.

FIG. 41 is a perspective view of a game controller according to one embodiment including at least two touch pads and a touch screen on the top side of the game controller similar to that shown in FIG. 38, and further includes a single touch pad on the right shoulder portion and a single touch pad on the left shoulder portion as shown in FIG. 36, and also on the bottom side includes a single touch pad on the right handle portion, and a single touch pad on the left handle portion as shown in FIG. 32 which each have multi-finger detection and control capability and can be mapped and selected for desired control functions and operations.

FIG. 42 is a top view of a game controller according to one embodiment including at least two touch pads and a touch screen on the top side of the game controller as shown in FIG. 38, and at least two touch pads on the right shoulder portion, and at least two touch pads on the left shoulder portion as shown in FIG. 34, and on the bottom side also includes at least two of touch pads on the right handle portion and at least two of touch pads on the left handle portion for actuating control of game play as shown in FIG. 28.

FIG. 43 is front view of a modular game controller according to one embodiment including at least two controls on the right shoulder portion, and also at least two controls on the left shoulder portion which can be selected by an individual for use and removably secured in order to customize the structure and performance of the game controller.

FIG. 44 is a side view of a stylus that is made at least in part of a plastics and/or rubber material for use on a finger and/or thumb of an individual with a touch pad and/or touch screen on a computer, pad, or game controller.

FIG. 45 is a bottom view of the stylus shown in FIG. 44 for use on a finger and/or thumb of an individual with a touch pad and/or touch screen on a computer, pad, or game controller.

FIG. 46 is an inside view of the stylus shown in FIG. 44 for use on a finger and/or thumb of an individual with a touch pad and/or touch screen on a computer, pad, or game controller.

FIG. 47 is a top view of a game controller according to one embodiment having symmetrical placement of removable thumbstick controls on the top side with the right thumbstick control removed to show one embodiment of a thumbstick receptacle for the right thumbstick control.

FIG. 48 is a top view of a game controller according to one embodiment having an asymmetrical placement of removable thumbstick controls on the top side with the right thumbstick control removed to show one embodiment of a thumbstick receptacle for the right thumbstick control, but also showing in a rectangle area beneath the game controller alternative embodiments of two removable retaining rings and/or gates having different geometric shapes such as a circle and an octagon which can be used to customize the play of thumbstick controls, and also two alternative removable trigger control modules, and two alternative removable bumper control modules, and two alternative removable thumbstick control modules.

FIG. 49 is a front view of a game controller according to one embodiment having removable bumper controls modules and also removable trigger controls modules for customizing the structure and performance of a game controller.

FIG. 50 is a side cross-sectional view of a removable control module that includes an inside wall, a tongue and/or groove, a mechanical actuator or lever for engaging with a finger of a user, a control mount, a retaining pin, a switch, a return spring, a wire or electrical conductor, a male electrical connector, and a male electrical contact.

FIG. 51 is a side cross-sectional view of a removable trigger control module that includes an inside wall, a tongue and/or groove, an electrically resistive pressure sensitive touch control, a wire or electrical conductor, a male electrical connector, and a male electrical contact. The electrically resistive touch control module can also possibly include an integrated circuit which is configured to be disposed on or in the control module, or alternatively, within the interior space defined by the interior side of the case of the game controller.

FIG. 52 is a side cross-sectional view of a removable control module that includes an inside wall, a tongue and/or groove, a capacitive control, a wire or electrical conductor, a male electrical connector, and a male electrical contact. The capacitive control module can also possibly include an integrated circuit which is configured to be disposed on or in the control module, or alternatively, within the interior space defined by the interior side of the case of the game controller.

FIG. 53 is a front view of a game controller according to one embodiment having removable bumper controls modules and also removable trigger controls modules for customizing the structure and performance of a game controller.

### DETAILED DESCRIPTION

Detailed descriptions of specific embodiments of the game controller and its actuator mechanisms and other features are disclosed herein. It can be readily understood that the disclosed embodiments are merely examples of the way in which certain aspects of the invention can be implemented and do not represent all of the ways the invention may be embodied. The game controller and its actuator mechanisms and other features described herein may be embodied in various alternative forms. Further, the drawing figures are not necessarily to scale and some features may be enlarged or minimalized to show certain details and features of particular embodiments. Some well-known structures, components, features, materials, and methods are not necessarily described in great detail for the sake of brevity and in order to focus upon the present invention. Any specific structural and functional details disclosed herein are not to be interpreted as limiting, but rather are provided for teaching one skilled in the art to variously employ the invention, and as basis for the claims.

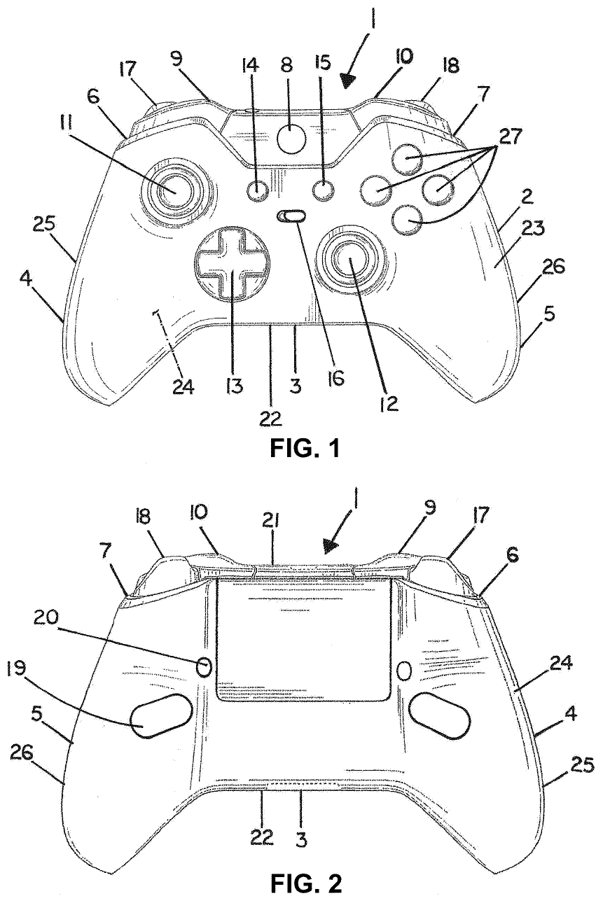

FIG. 1 is a top view of a game controller 1 according to one embodiment including a left thumbstick control 11 and a right thumbstick control 12 located asymmetrically relative to the left handle portion 4, the middle portion 3, and the right handle portion 5 of the game controller 1 similar to the Microsoft Xbox One® game controller which is believed to be represented in U.S. D709,882 S by Morris et al. The embodiment of a game controller 1 shown in FIG. 1 includes a case 2 having a front side 21, back side 22, top side 23, bottom side 24, left side 25, right side 26, left shoulder portion 6, a right shoulder portion 7, a middle portion 3, a left handle portion 4, and a right handle portion 5. As shown, the top view of the controller 1 shows an on and off control 8, a left selection control 14 which can be used as a back control switch and for other functions, a right selection control 15 which can be used as a menu control switch and for other functions, a mapping preset control 16 for changing between a plurality of mapping presets, a left trigger control 9 and a left bumper control 17 on the left shoulder portion 6, a right trigger control 10 and a right bumper control on the right shoulder portion 7, four action controls 27 which can be labeled A, B, X, and Y, and a cross-shaped directional pad control 13. Other mechanical actuators, levers, controllers and switches for possible use in a game controller can be push button, slide, rocking, rotating, throwing, pulling, key-turning, magnetic, and toggle actuated.

FIG. 2 is a bottom view of the game controller 1 shown in FIG. 1. Unlike, the Microsoft Xbox One® and Microsoft Xbox One Elite® game controllers which are believed to be represented in U.S. D709,882 S by Morris et al. and U.S. D772,988 S by Kujawski et al., the embodiment which is shown in FIG. 1 includes paddle controls 19 which are secured on the left handle portion 4, and also the right handle portion 5 of the game controller 1. The game controller 1 shown in FIG. 2 also includes a left bumper control 17 and left trigger control 9 on the left shoulder portion 6, a right bumper control 18 and a right trigger control 10 on the right shoulder portion 7, and two hair trigger lock controls 20.

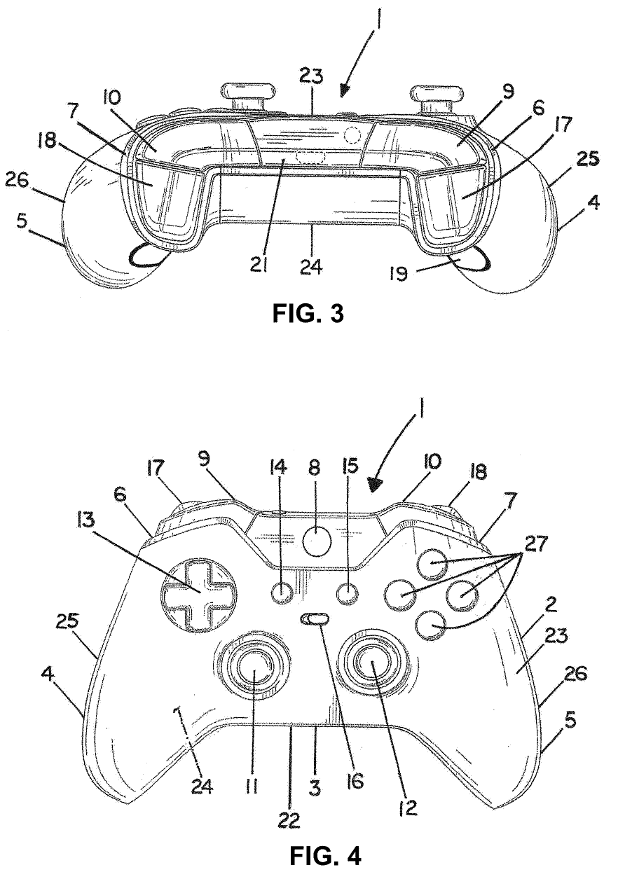

FIG. 3 is a front view of the game controller 1 shown in FIG. 1 showing a left trigger control 9 and a left bumper control 17 on the left shoulder portion 6, and a right trigger control 10 and a right bumper control 18 on the right shoulder portion 7 of the game controller 1, and a portion of the two paddle controls 19 can also be seen.

FIG. 4 is a top view of a game controller 1 according to one embodiment which is generally similar to that shown in FIG. 1, but having a symmetrical placement of the left thumbstick control 11 and right thumbstick control 12 on the top side 23.

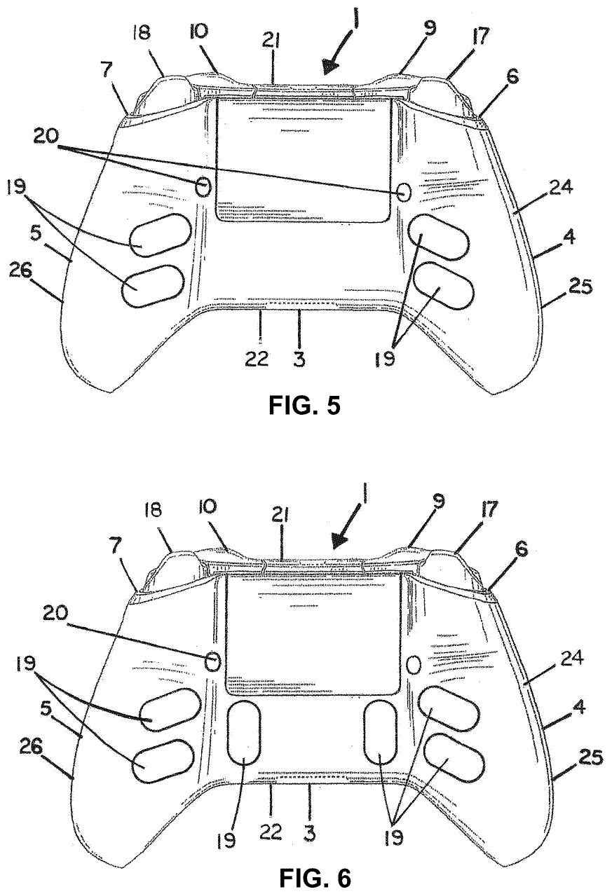

FIG. 5 is a bottom view of a game controller 1 according to one embodiment that is generally similar to that shown in FIG. 2, but which includes two paddle controls 19 on the left handle portion 4 and two paddle controls 19 on the right handle portion 5 of the game controller 1. It can be readily understood that users normally have five fingers on their hands including the thumb. Counting the thumb as the first finger, the index finger is the second finger, the middle finger is the third finger, and the fourth finger, and then the fifth finger which is normally the smallest. The paddle controls 19 can be actuated by a user's third or middle finger and also a user's fourth and fifth fingers.

FIG. 6 is a bottom view of a game controller 1 according to one embodiment that is generally similar to that shown in FIG. 5, but which further includes two controls on the middle portion 3 of the game controller 1. The two controls can be a toggle or paddle controls, and other mechanical actuators, levers, controllers and switches for possible use in a game controller can be push button, slide, rocking, rotating, throwing, pulling, key-turning, and magnetic actuated.

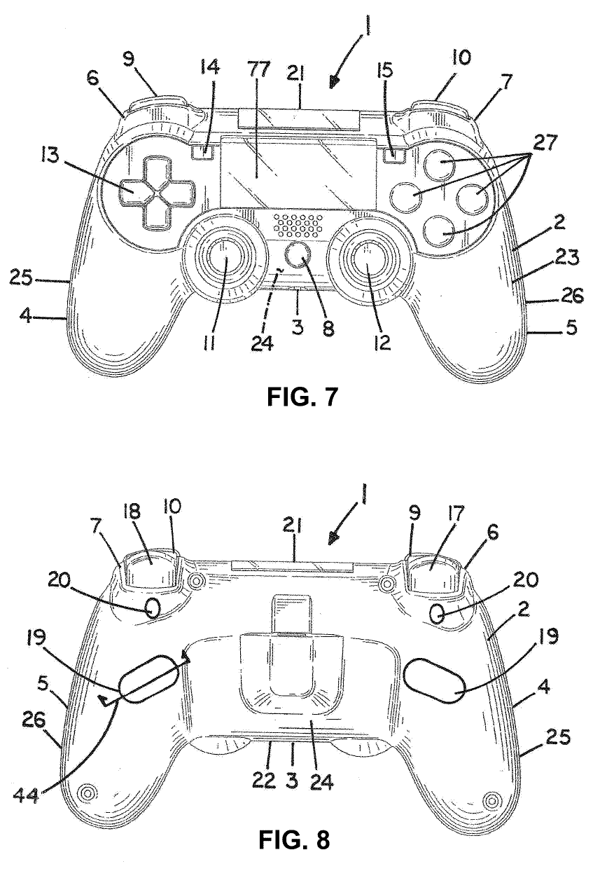

FIG. 7 is a top view of a game controller 1 according to one embodiment which has a left thumbstick control 11 and a right thumbstick control 12 located symmetrically relative to the left handle portion 4, the middle portion 3, and the right handle portion 5 of the game controller 1 on the top side 23 similar to the Sony® PS4 game controller which is believed to be represented in U.S. D715,296 S by Huang. The game controller 1 shown in FIG. 7 includes a case 2 having a front side 21, back side 22, top side 23, bottom side 24, left side 25, right side 26, a left shoulder portion 6, a right shoulder portion 7, a middle portion 3, a left handle portion 4, and a right handle portion 5. As shown, the top view of the controller 1 shows an on and off control 8, a left selection control 14 which can be used as a back control and for other functions, a right selection control 15 which can be used as a menu control and for other functions, a control 16 for changing between mapping presets, a left trigger control 9 on the left shoulder portion 6, a right trigger control 10 on the right shoulder portion 7, four action controls 27 which can be labeled A, B, X, and Y, a cross-shaped directional pad control 13, and a touch control screen 77.

FIG. 8 is a bottom plan view of the game controller 1 shown in FIG. 7, but which includes a paddle control 19 on the left handle portion 4 and a paddle control 19 on the right handle portion 5 of the game controller 1. Unlike, the Microsoft Xbox One® and Microsoft Xbox One Elite® game controllers which are believed to be represented in U.S. D709,882 S by Morris et al. and U.S. D772,988 S by Kujawski et al., the embodiment which is shown in FIG. 7 includes paddle controls 19 which are secured on the left handle portion 4, and also the right handle portion 5 of the game controller 1. The game controller 1 shown in FIG. 8 also includes a left bumper control 17 and left trigger control 9 on the left shoulder portion 6, a right bumper control 18 and a right trigger control 10 on the right shoulder portion 7, and two hair trigger lock controls 20.

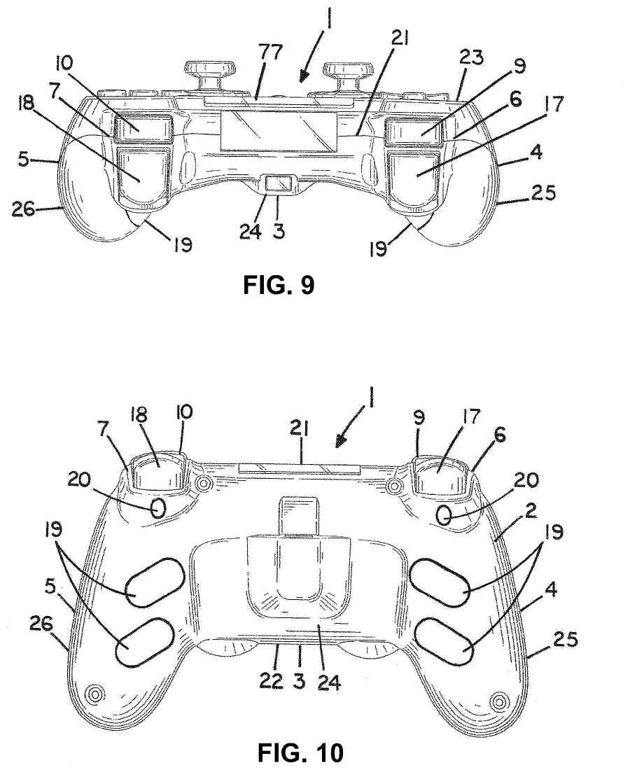

FIG. 9 is a front view of the game controller shown in FIG. 7 showing a left trigger control 9 and a left bumper control 17 on the left shoulder portion 6, and a right trigger control 10 and a right bumper control 18 on the right shoulder portion 7 of the game controller 1, and a portion of the paddle controls 19, and a touch screen control 77 can also be seen.

FIG. 10 is a bottom plan view of a game controller 1 according to one embodiment that is generally similar to that shown in FIG. 8, but which includes two paddle controls 19 on the left handle portion 4 and two paddle controls 19 on the right handle portion 5 of the game controller 1.

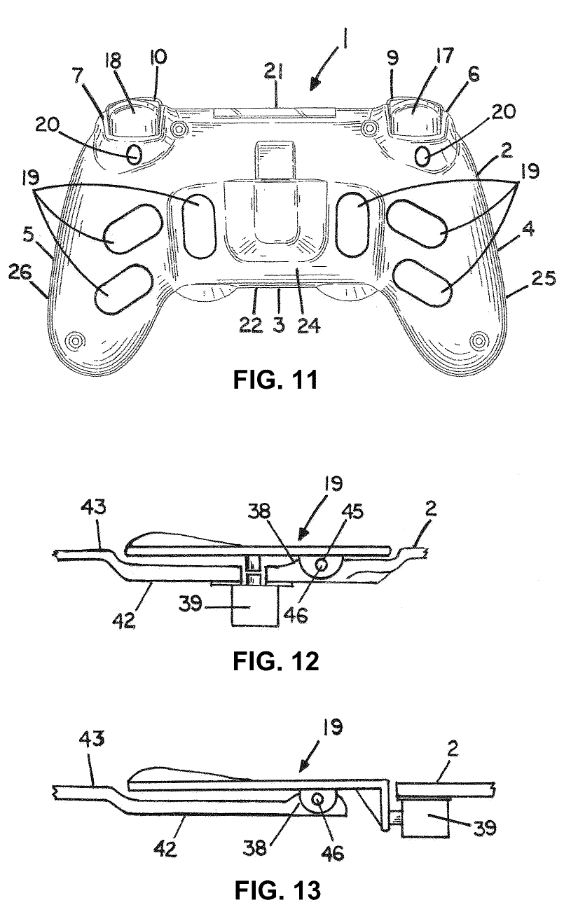

FIG. 11 is a bottom plan view of a game controller 1 according to one embodiment that is generally similar to that shown in FIG. 8, but which further includes two paddle controls 19 in the middle portion of the game controller 1.

FIG. 12 is a cross-section view of the left handle portion 4 of the game controller 1 shown in FIG. 8 taken along line 44, showing a portion of the interior side 42 of the case 2 and a push button control switch 39 which can be actuated by paddle control 19. The control mount 38 and switch 39 for use can be generally similar to those disclosed in the drawing FIGS. 5, 6, 15, 16, and the specification of published U.S. Patent Application 20160346682 A1 by Burgess et al., and/or as shown and discussed herein. For example, U.S. 20160346682 A1 by Burgess et al. shows in drawing FIG. 5 a portion of a game controller including four single pole push button momentary control switches that are normally associated with open circuits in the rest position and which can be made to make contact and close their corresponding circuits enabling electrical energy to flow to the game console logic board or other destination where user activation of the switch is sensed when actuated with a paddle control by a user. In this regard, when actuated a paddle control depresses the bush button on the control switch below to close the corresponding circuit. A similar structure and push bottom control switch 39 can be used in a game controller 1 according to the embodiment which is shown in FIG. 8, herein. Alternatively, the paddle control switch 39 could include a normally closed switch 39 associated with a closed circuit which goes to ground in the rest position. The control switch 39 can be single pole push button momentary control switch that is normally associated with a first closed circuit 81 which goes to ground when in the closed and resting position, but which can be made to open and therefore break the first closed circuit 81 which goes to ground and thereby cause electrical energy to instead flow in a second closed circuit 82 to the game console logic board or other destination where user activation of the switch is sensed when the control switch 39 is actuated with the paddle control 19 by a user. One possible advantage of the latter type of normally closed switch and wiring configuration is that it could possibly require less movement and deflection for effective operation and/or less wear on the contact surfaces resulting in greater durability.

FIG. 13 is a cross-sectional view showing a portion of the interior side 42 of the case 2 of a game controller 1 and a push button control switch 39 according to one embodiment which can be activated with a paddle control 19 by a user which is generally similar to that shown in FIG. 8, taken along line 44. The paddle control 19 design and sideways position of the push button control switch 39 is such that depressing the paddle control 19 causes the control switch 39 to be actuated. The push button control switch 39 can be a single pole push button momentary control switch 39 that is normally associated with an open circuit in the rest position and which can be made to make contact and close its corresponding circuit enabling electrical energy to flow to the game console logic board or other destination where user activation of the switch is sensed when the paddle control 19 is actuated by a user. Alternatively, the control switch 39 can be single pole push button momentary control switch that is normally associated with a first closed circuit 81 which goes to ground in the normally closed and resting position, but which can be made to break and open the first closed circuit 81 which goes to ground and thereby cause electrical energy to instead flow in a second closed circuit 82 to the game console logic board or other destination where user activation of the control switch 39 is sensed when the control switch 39 is actuated with a paddle control 19 by a user.

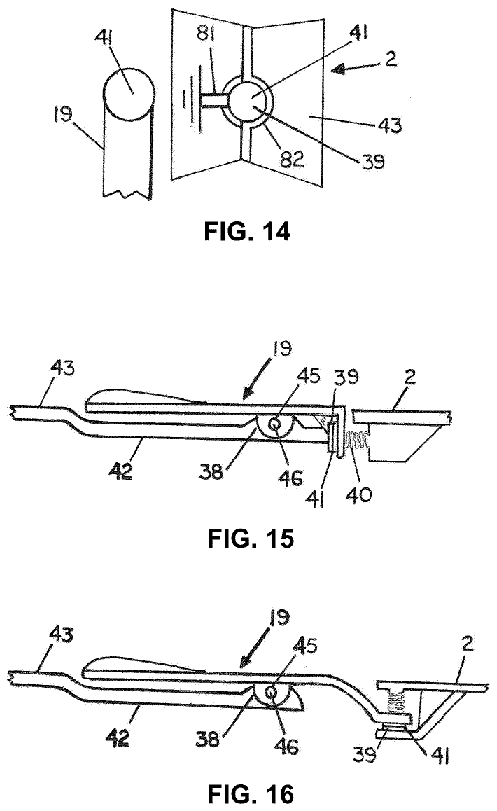

FIG. 14 is a schematic view which relates to a portion of the case 2 of an alternative embodiment of a game controller 1 and a control switch 39 according to one embodiment which can be activated with a paddle control 19 including a contact 41. The control switch 39 is normally associated with a first closed circuit 81 which goes to ground in the closed and resting position, but which can be made to break and open the first closed circuit 81 which goes to ground and thereby cause electrical energy to instead flow in a second closed circuit 82 which is no longer grounded, and then to the game console logic board or other destination where user activation of the control switch 39 is sensed when the control switch 39 is actuated with a paddle control 19 by a user. As shown in FIG. 14, the second closed circuit 82 which goes to the game console logic board or other destination where user activation of the control switch 39 is sensed is on one side or portion of a contact 41 and the first closed circuit 81 which goes to ground is located in close proximity on another side or portion of the contact 41, but is not in direct electronic communication with the second closed circuit 82. The paddle control 19 includes a corresponding contact 41 which is electrically conductive so that when the control switch 39 is in the normal closed and resting position there is electronic communication between the first closed circuit 81 and the second closed circuit 82 which effectively grounds the second closed circuit 82. However, when the paddle control 19 is actuated, the electronic communication between the first closed circuit 81 which goes to ground and the second closed circuit 82 is broken, and there is then electronic communication to the game console logic board or other destination where user activation of the control switch 39 is sensed when the control switch 39 is actuated by the paddle control 19.

FIG. 15 is a cross-sectional view of a portion of the case 2 of a game controller 1 and a control switch 39 according to one embodiment which is generally similar to that shown in FIG. 8, taken along line 44, and which can be activated with a paddle control 19 by a user. The paddle control 19 design and sideways position of the control switch 39 spring 40 and contact 41 is such that depressing the paddle control 19 causes the control switch 39 to be actuated. As shown, the control switch 39 is normally associated with a first closed circuit 81 which goes to ground in the closed and resting position, but can be made to break and open the first closed circuit 81 which goes to ground and thereby cause electrical energy to instead flow in a second closed circuit 82 to the game console logic board or other destination where user activation of the control switch 39 is sensed when the control switch 39 is actuated with a paddle control 19 by a user.

FIG. 16 is a cross-sectional view of a portion of the case 2 of a game controller 1 and a control switch 39 according to one embodiment which is generally similar to that shown in FIG. 8, taken along line 44, and which can be activated with a paddle control 19 by a user. The paddle control 19 design and approximately vertical position of the control switch 39 spring 40 and contact 41 is such that depressing the paddle control 19 causes the control switch 39 to be actuated. As shown, the control switch 39 is normally associated with a first closed circuit 81 which goes to ground in the closed and resting position, but can be made to break and open the first closed circuit 81 which goes to ground and thereby cause electrical energy to instead flow in a second closed circuit 82 to the game console logic board or other destination where user activation of the control switch 39 is sensed when the control switch 39 is actuated with a paddle control 19 by a user.

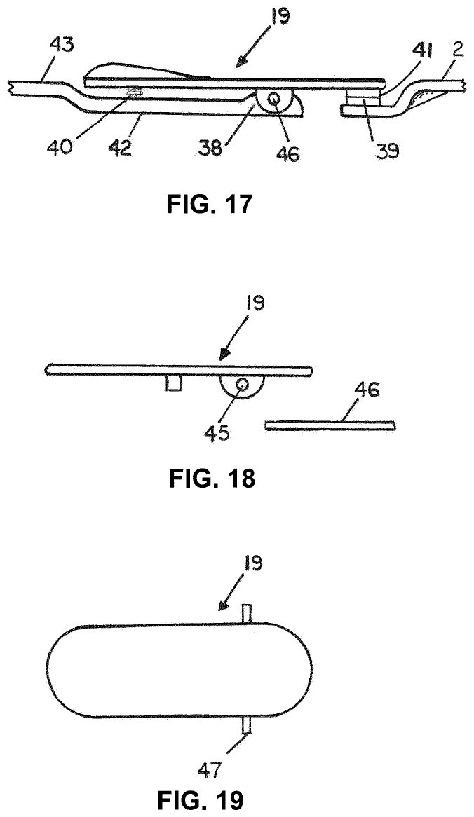

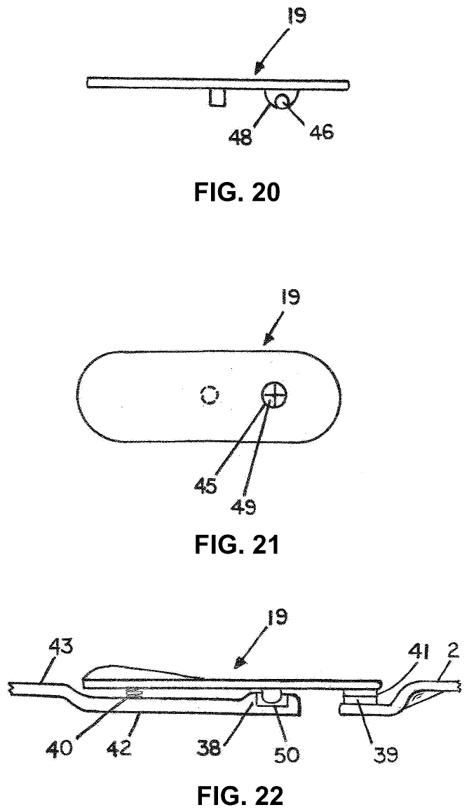

FIG. 17 is a cross-sectional view of a portion of the case 2 of a game controller 1 and a control switch 39 according to one embodiment which is generally similar to that shown in FIG. 8, taken along line 44, and which can be activated with a paddle control 19 by a user. The paddle control 19 design and external position of the control switch 39 spring 40 and contact 41 is such that depressing the paddle control 19 causes the control switch 39 to be actuated. As shown, the control switch 39 is normally associated with a first closed circuit 81 which goes to ground in the closed and resting position, but can be made to break and open the first close circuit 81 which goes to ground and thereby cause electrical energy to instead flow in a second closed circuit 82 to the game console logic board and/or integrated circuit 121 or other destination where user activation of the control switch 39 is sensed when the control switch 39 is actuated with a paddle control 19 by a user. In this alternative embodiment of a game controller 1, the paddle control 19, control mount 38, retaining pin 46, spring 40, and contact 41 are all on the exterior side 43 of the case 2 which can facilitate customization and also removal and replacement of component parts. Different configurations of alternative paddle controls 19, but also different alternative springs 40 having different stiffness, and also different alternative contacts 41 can be used as desired by a user to customize a game controller 1 for game play. The contact 41 can include a conductive metal, but also a plastic, thermoplastic or rubber material which can serve as a pad. The inclusion of carbon black can render a thermoplastic or rubber material electrically conductive. Further, different paddle control 19 and switch 39 embodiments can be removably attached to game controllers 1 according to alternative embodiments using different structures and means, e.g., a paddle control 19 can alternatively include: an opening 45 for receiving a removable retaining pin 46 as shown in FIG. 18; an integral axle 47 for snap fitting into a mating female receptacle as shown in FIG. 19; a semi-circular receptacle 48 for mating with a pin fixed in the case 2 or a removable retaining pin 46 as shown in FIG. 20; an opening 45 for receiving a screw 49 as shown in FIG. 21; and, a magnet 50 as shown in FIG. 22, and the like.

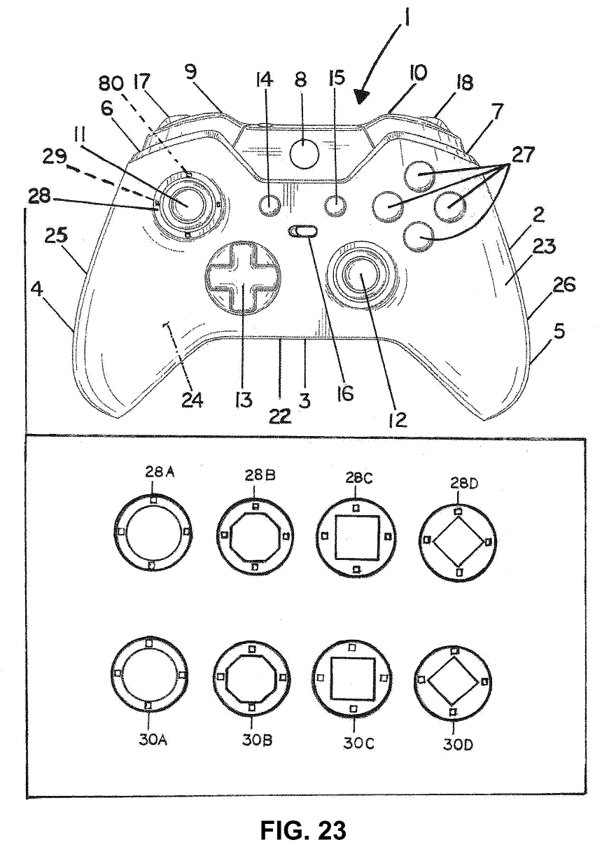

FIG. 23 is a top plan view of a game controller 1 generally similar to that shown in FIG. 1, showing a case 2 including at least one receptacle 29 for receiving different alternative removable retaining rings 28 having different geometric shapes for possible use in securing and customizing the play of a joystick control such as thumbstick control 11 and/or thumbstick control 12. The different alternative retaining rings 28 can include an integral gate 30 and/or secure a gate 30 comprising a particular geometric shape for customizing the play of at least one joystick control such as thumbstick control 11 and/or thumbstick control 12. As shown in the box portion of FIG. 23 different optional retaining rings 28 including an integral gate 30 such as a circular retaining ring 28A, octagonal retaining ring 28B, square retaining ring 28C, or a diamond retaining ring 28D can include four male snap fit appendages 79 for inserting into mating female snap fit openings 80. Alternatively, individual removable circular gate 30A, octagonal gate 30B, square gate 30C, or diamond gate 30D can include registered notches and/or openings 45 for permitted the snap fit appendages 79 on a circular retaining ring 28A to pass therethrough and then be removably secured to the receptacle 29 portion of the case 2 are also shown. A selectively removable retaining ring 28 and/or gate 30 can have a geometric shape selected from the group consisting of: a circular shape, an octagonal shape, a square shape, a diamond shape, and other geometric shapes. The retaining rings 28 and/or gates 30 can be associated with 8 way, 4 way, 2 way, and other functions and operations associated with game play.

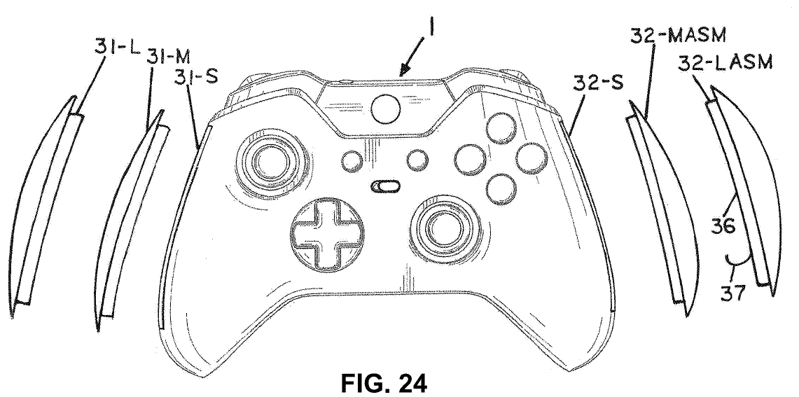

FIG. 24 is a top view of a game controller 1 similar to that shown in FIG. 1 showing different customizable and selectively removable ergonomic left grip 31 and right grip 32 for accommodating users having small, medium, and large hand sizes. In particular, the left grip 31 and right grip 32 can be removably attached using a friction fit, Velcro® loop and pile, adhesive means such as self-adhesive strips 36 having a peel ply layer 37, screws, rivets, snap fit structures, other mating male and female structures, and the like. The left grip 31 can extend along a portion of the left side 25 of the case 2 in an area between the left shoulder 6 and back side 22 of the left handle 4, and the right grip 32 can extend along a portion of the right side 26 of the case 2 in an area between the right shoulder 7 and back side 22 of the right handle 5 in order to better fit the palm of a user's hand as desired. The left grip 31 and right grip 32 can then be customized and removably attached to best fit the hand size, comfort, and gaming preference of the user. In the top view shown in FIG. 24, the small size left grip 31S and right grip 32S can fit flush or nearly flush with the case 2, but the medium size left grip 31M and right grip 32M and also the large size left grip 31L and right grip 32L can project by different amounts from the normal profile of the case 2. Shown in FIG. 24 is a game controller 1 including small size left grip 31-S installed, and also showing a medium left grip 31-M, a large left grip 31-L, and a small right grip 32-S which are relatively symmetrical in shape, but also a medium right grip 32-MASYM and large right grip 32-LASYM which have an asymmetrical shape. It is possible to reverse and flip the direction of the asymmetrical grips so that the thicker portion can be either placed closer to the front 21 or the back 22 of the game controller 1. Moreover, it is possible that a user may desire and choose to use one sized grip 31 having a particular symmetrical or asymmetrical configuration on the left side 25 and a different sized grip 32 on the right side 26 of the game controller 1.

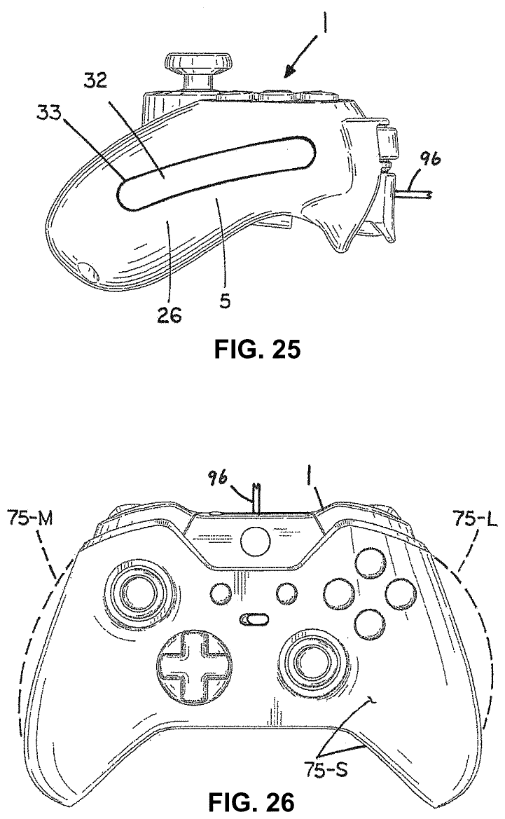

FIG. 25 is a right side 26 view of the game controller 1 shown in FIG. 7. As shown in FIG. 12, the right grip 32 can be customized and removably secured to the right side 26 of the right handle 5 in a location between the shoulder 7 and the back side 22 of the right handle 5. The case 2 can include a female recess 33 for inserting a male portion 34 of the right grip 32. A male portion of the right grip 32 can then be removably friction fit and/or snap fit in place on the right side 26 of the right handle 5 to secure the right grip 32. If desired, a double-sided strip of self-adhesive tape 36 having a peel ply layer 37 can also be applied to the male portion 34 of the right grip 32 in order to help secure it in place, as shown on the right side of FIG. 24. Optionally, Velcro® loop and pile, screws, rivets, mechanical snap fit, and other mating male and female structures can be used, and the like. In FIG. 25, the possible use of a wire or fiber optical cable 96 is also shown with part of the cable 96 being broken away. Alternatively, a game controller 1 can be connected to a computer or game console using wireless communication.

FIG. 26 is a top view of a resilient stretch to fit game control cover 75 which can be made using a silicone or thermoplastic rubber material, and in ergonomic configurations to fit users having small 75S, medium 75M, and large 75L hand sizes. The possible use of a wire or fiber optical cable 96 is also shown in FIG. 26 with part of the cable 96 being broken away. Alternatively, a game controller 1 can be connected to a computer or game console using wireless communication.

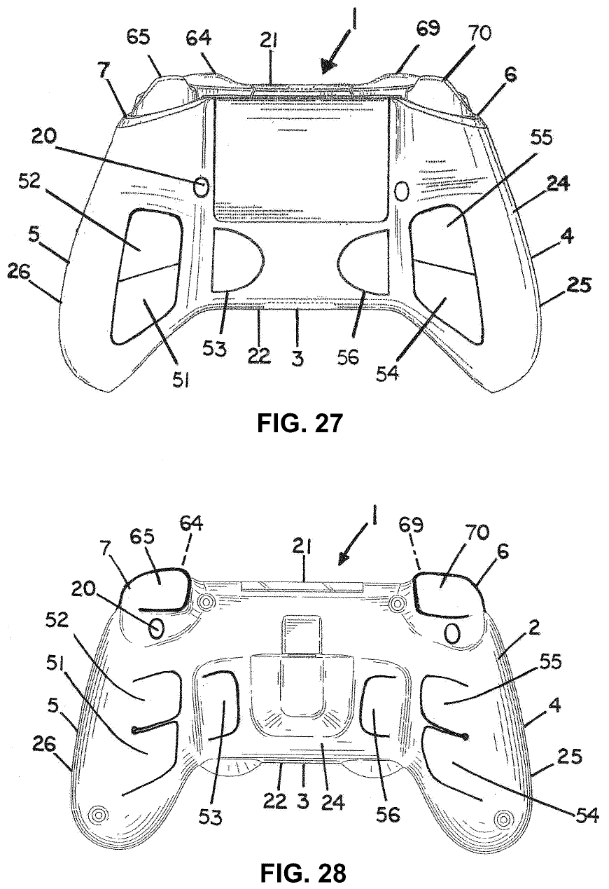

FIG. 27 is bottom view of a game controller 1 according to one embodiment which can include controls and features resembling those shown on the top side 23 of the embodiment shown in FIG. 1, but instead includes on the bottom side 24 two push keys 51 and 52 on the right handle portion 5, a push key 53 on the right part of the middle portion 3, two push keys 54 and 55 on the left handle portion 4, and another push key 56 on the left part of the middle potion 3 for actuating control switches 39, and on the front side 21 near the right shoulder portion 7 includes a push right trigger key 64 and right bumper key 65, and on the front side 21 near the left shoulder portion 6 includes a push left trigger key 69 and left bumper key 70. The control switches 39 can be push-button and similar to those which are commonly used on mouse devices. Computer mouse devices sometimes use OMRON® brand switches type DZFC-7N in 10 or 20 mm. The structure and function of the selection keys and switches used in keyboards and various mouse devices which can be suitable for use are disclosed in the following U.S. patents: U.S. Pat. No. 4,508,942 by Inaba, U.S. Pat. No. 6,313,826 B1 by Schrum et al., U.S. Pat. No. 6,135,886 by Armstrong, U.S. Pat. No. 6,256,013 B1 by Siddiqui, U.S. Pat. No. 6,933,925 B1 by Gibbons, U.S. Pat. No. 7,205,980 B2 by Maroun, U.S. Pat. No. 7,345,674 B2 by McLoone et al., U.S. Pat. No. 7,656,389 B2 by Adan et al., U.S. Pat. No. 7,939,774 B2 by Corcoran et al., U.S. Pat. No. 7,948,474 B2 by Chatterjee et al., U.S. Pat. No. 7,995,035 B2 by Wu, U.S. Pat. No. 8,547,334 B2 by Min-Liang et al., and U.S. Pat. No. 9,372,588 B2 by Dietz et al., all of these patents are hereby incorporated by reference herein. Several of these patents disclose pressure sensitive switches which can vary the electrical signal communicated during actuation depending upon the pressure being applied such as U.S. Pat. No. 6,135,886 by Armstrong, and U.S. Pat. No. 9,372,588 B2 by Dietz et al., and such can be suitable for use as desired.

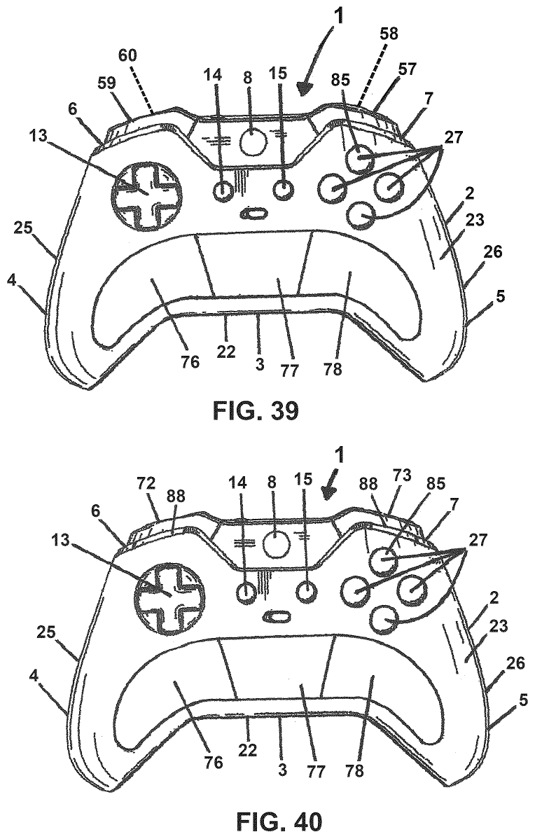

For example, a game controller can include and use force sensing potentiometers also known as pressure sensitive touch switches and/or touch pads which sense force and/or position and use variable resistance induced by the finger pressure of an individual to control movement and/or other action in a video game. Several of the thin or thick film FSR, that is, Force Sensing Resistor products made by the OHMITE Manufacturing Company of Warrenville, Illinois can be used, and in particular, the products identified as FSR04, FSR05, FSR06, and FSR07 which can be viewed on their website www.ohmite.com and purchased online from www.mouser.com. The OHMITE company's FSR04 and FSR05 products can be used for the left selection control 14, right selection control 15, the action controls 27, and other controls which can be disposed on the top side 23 of a game controller 1 on raised protrusions 85, as shown in drawing FIG. 39, or be otherwise located on the top side 23, bottom side 24, and other sides or surfaces on the exterior side 43 of a game controller 1. These force sensing switches can be used instead and/or as an alternative to the four or more mechanical push button controls, and in particular, the cluster of four push button controls which are often labeled A, B, X, and Y and found on the top side of conventional game controllers such as the aforementioned game controllers made by Sony® and the Xbox® game controllers made by the Microsoft Corporation. Further, the OHMITE FSR04, FAR05 products, and in particular, the FSR06 and FSR07 products can be disposed on the left shoulder portion 6 and right shoulder portion 7 near and/or on the front side 21 of a game controller 1 as shown in drawing FIG. 34, and these force sensing switches can then be used as an alternative for the left trigger control, left bumper control, right trigger control, and right bumper control instead of conventional mechanical controls which typically include a relatively large mechanical actuator or lever which rotates around a retaining pin, and a coiled return spring which can be used to exert force on a switch. Most of the OHMITE products have a life expectancy of ten million cycles and they can provide a long service life. According to OMHITE, the actuation force using one hundred samples to reach 10 MΩ when using the OHMITE FSR04 product is less than 20 grams, and the actuation force of the FAR05 product is less than 30 grams, and the actuation force of the FSR06 and FSR07 products is less than 15 grams. Some individuals who use computers, pads, and game controllers like to rest their fingers on some of the controls, and the sensitivity of those controls can affect performance. In this regard, a sensitivity of less than 10 grams can be too sensitive and often result in the unintentional actuation of a touch control. On the other hand, an individual's speed and performance when using a touch control can be impaired if and when the required amount of force to actuate the control is too great. Accordingly, it can be advantageous that the actuation force for a touch control not exceed 50 grams. A typical range of actuation force for a resistive force sensitive touch control for use on a game controller is in the range of between about 10-50 grams, and within this range the more typical range is in the range of between about 15-30 grams. The measured force value in grams regarding the pressure sensors made by OHMITE, and others, is taken from a force curve which is generated using a test protocol using a domed 9 mm diameter 45 Shore A silicone tip specified in ASTM F1578-07(2014) entitled Standard Test Method For Contact Closure Cycling Of A Membrane Switch, hereinafter simply identified and recited as ASTM 1578, to apply force to the center of the pressure sensor being tested, and the tip moves down slowly, gradually increasing the force which is then measured with a loadcell and the resistance is recorded using a digital to analog converter. For example, Norman Tools Test Equipment & Supplies of Evansville, Indiana makes a PFTE-1 Pneumatic Finger Tester which can be operated using test method reference ASTM 1578. This device can be calibrated using a scale to provide accurate readings in grams when used to apply a force to the domed 9 mm diameter 45 Shore A silicone tip used during testing. ASTM F2592-16 entitled Standard Test Method For Measuring The Force-Displacement Of A Membrane Switch, hereinafter simply identified and recited as ASTM 2592, is another test method which could possibly be used to test a typical range of force between about 10-50 grams, and within this range the more typical range is in the range of between about 15-30 grams.

In addition, OHMITE makes a round or donut shaped force sensing resistor product identified as FSP03CE which can sense both pressure and position, and this product can be used instead and/or as an alternative to at least one of the conventional left joystick 11 and/or left directional pad controls 13, which are commonly disposed on the top side 23 of conventional game controllers, as shown in drawing FIG. 38.

FIG. 28 is bottom view of a game controller 1 according to one embodiment which can include controls and features resembling those shown on the top side 23 of the embodiment shown in FIG. 7, but instead includes on the bottom side 24 two push keys 51 and 52 on the right handle portion 5, a push key 53 on the right part of the middle portion 3, two push keys 54 and 55 on the left handle portion 4, and another push key 56 on the left part of the middle potion 3 for actuating control switches 39, and on the front side 21 near the right shoulder portion 7 includes a push right trigger key 64 and right bumper key 65, and on the front side 21 near the left shoulder portion 6 includes a push left trigger key 69 and left bumper key 70. The control switches 39 can be push-button and similar to those which are commonly used on mouse devices, as discussed above in connection with FIG. 27.

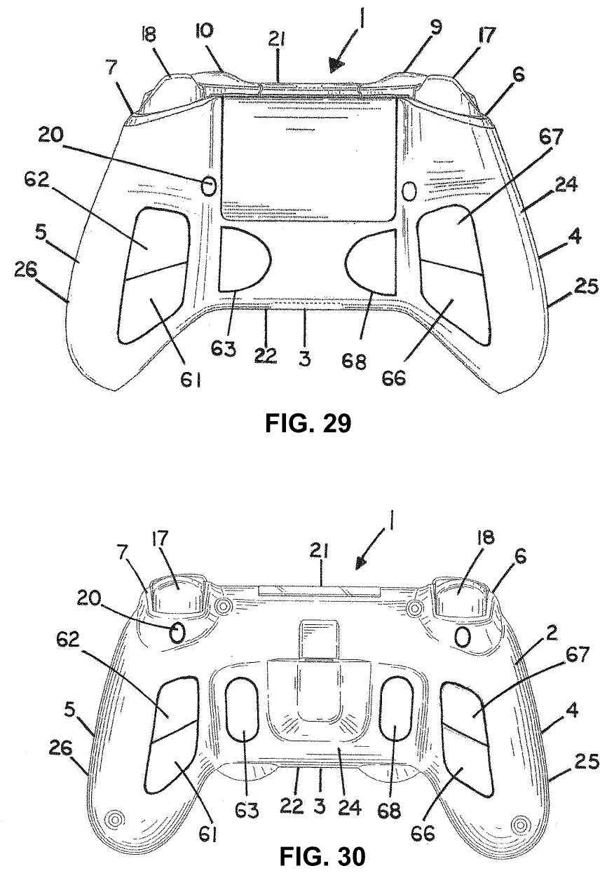

FIG. 29 is bottom view of a game controller 1 according to one embodiment which can include controls and features resembling those shown on the top side 23 and front side 21 of the embodiment shown in FIG. 1, but instead includes on the bottom side 24 two touch pads 61 and 62 on the right handle portion 5, a touch pad 63 on the right part of the middle portion 3, two touch pads 66 and 67 on the left handle portion 4, and a touch pad 68 of the left part of the middle portion 3 for actuating control of game play. The structure and function of touch pads is disclosed in numerous patents by the Microsoft Corporation including: U.S. Pat. No. 7,659,887 B2 by Larsen et al., U.S. Pat. No. 7,813,774 B2 by Perez-Noguera, U.S. Pat. No. 7,880,727 B2 by Abanami et al., U.S. Pat. No. 8,581,852 B2 by lzadi et al., U.S. Pat. No. 8,648,822 B2 by Weiss, U.S. Pat. No. 8,665,244 B2 by Large et al., U.S. Pat. No. 8,754,855 B2 by Duncan et al., U.S. Pat. No. 8,884,907 B2 by Townsend et al., U.S. Pat. No. 8,913,019 B2 by Zhao et al., U.S. Pat. No. 8,933,912 B2 by Ambrus et al., U.S. Pat. No. 8,982,051 B2 by Rosenfeld et al., U.S. Pat. No. 9,098,117 B2 by Lutz et al., U.S. Pat. No. 9,152,288 B2 by Dietz, U.S. Pat. No. 9,174,124 B2 by Hammontree et al., U.S. Pat. No. 9,223,471 B2 by Buxton et al., U.S. Pat. No. 9,250,753 B2 by Westhues et al., U.S. Pat. No. 9,285,907 B2 by Weiss et al., U.S. Pat. No. 9,335,900 B2 by Weiss et al., U.S. Pat. No. 9,354,804 B2 by Berkes et al., U.S. Pat. No. 9,377,646 B2 by Westhues et al., U.S. 9,436,338 B2 by Keller et al., U.S. Pat. No. 9,501,218 B2 by Hwang et al, and U.S. Pat. No. 9,519,419 B2 by Hickley et al., and all of these patents are hereby incorporated by reference herein. Within this group of patents: U.S. Pat. No. 8,913,019 B2 by Zhao et al. discloses multi-finger detection and control, U.S. Pat. No. 8,982,051 B2 by Rosenfeld et al. discloses a touch pad including multi-finger detection and control on a curved geometric feature; U.S. 9,377,646 B2 by Westues et al. disclosures a touch control including an oblique electrode matrix; U.S. Pat. No. 9,174,124 B2 by Hammontree et al. disclosures touch directional controls having similar function to analog joysticks; and, U.S. Pat. No. 8,581,852 B2 by lzadi et al. and U.S. Pat. No. 8,665,244 B2 by Large et al. disclose structures and methods of optical touch detection and actuation. Other patent applications which disclose finger actuated and/or touch sensitive controls include U.S. 20200353349 A1 by Palmer et al. and U.S. 20190291000 A1 by Campbell et al. which are assigned to the Valve Corporation of Bellevue, Washington, and both of these patent applications are hereby incorporated by reference herein. Touch pads that work upon physical contact by a user via impedance or optical sensor(s) can be faster than mechanical switches, and also possibly more durable. For example, touch switches or touch pads, trackpads, and/or modules which are capacitive instead of pressure sensitive, and which can sense touch and/or position and/or movement can be used in a game controller. In this regard, electrical resistance is the opposition to the flow of electric current in the circuit. Impedance is opposition to the flow of current because of any three components that is resistive, inductive, or capacitive, and is a combination of both resistance and reactance in a circuit. The direct contact and/or proximity of a user's finger or thumb can change the capacitance and/or impedance of a capacitive control and/or its associated circuit so as to actuate the control and initiate a command. In this regard, the typical range of the distance required to actuate a capacitive control is the range between and including direct contact of a finger of a user, that is, no or 0 distance, and a distance of the same finger equal to or less than ¼ inch or 6.35 mm from the capacitive control. When an even faster response time is desired for initiating a command, function, or operation, the typical range of the distance required to actuate a capacitive control is the range between and including direct contact of a finger of a user and a distance of the same finger equal to or less than ⅛ths inch or 3.175 mm from the capacitive control.

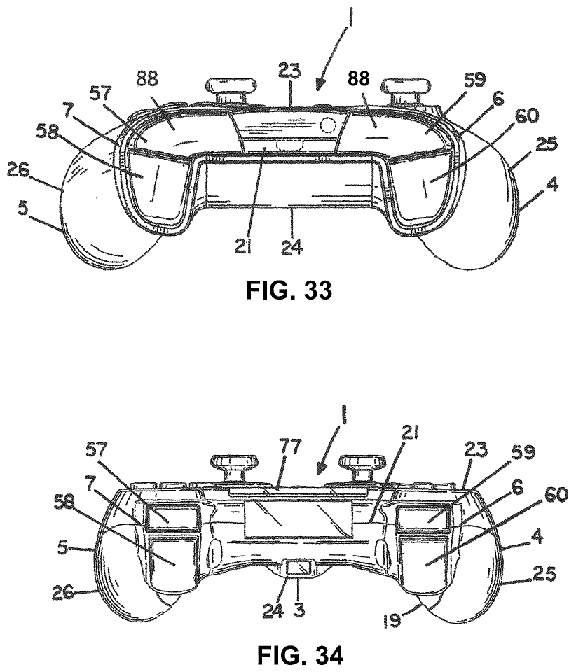

One manufacturer and/or distributer of capacitive switches is Adafruit Industries of New York, New York which has a website www.adafuit.com. The Adafruit 1374 standalone capacitive one channel touch sensor identified as part number AT42QT1012 can be used instead of conventional mechanical switches for the bumpers and/or triggers of a game controller which typically include a hinged mechanical actuator or lever component made of a thermoplastic material which rotates around a retaining pin and also a coiled metal return spring which can be caused to exert force on a switch. A capacitive switch is quite sensitive and can be triggered when an individual's finger gets in close proximity to the contact surface of the switch, and the switch will then remain in the on position for as long as the individual's finger remains in contact with the surface of the switch. The Adafruit 1374 touch sensor can also be remotely triggered if a conductive material which is in contact the top surface of the sensor and extends therefrom is touched by the finger of an individual. Another manufacturer of a capacitive switch module that includes four touch pads is the OSEPP product 4DTOUCH-01 of Leo Sales, Ltd. of Richmond, British Columbia, Canada, and which can be viewed on the website www.OSEPP.com. Another example of a capacitive switch module that include eight touch pads is the Anself brand TTP226 8-Way Channel Capacitive Touch Switch Digital Touch Sensor Module PCB Board which has a working voltage between 2.4-5.5 volts and is sold on the website www.Walmart.com. A wire or other conductive material can be connected or otherwise be placed in electrical communication with one or more of the four touch pads and extend to a conductive surface, metallic element, and/or touch pad on the exterior side 43 a game controller where an individual can make direct contact or alternatively proximate or near contact with their finger in order actuate or trigger the capacitive switch. A conductive wire, a thin piece of aluminum foil or other conductive metal, a conductive paint, a conductive plastic, and/or a conductive wire which is connected to a conductive element 88 which can possibly be made of metal and is disposed on the exterior side 43 of a game controller 1 can be used to make an electrical connection to the aforementioned OSEPP capacitive switch module, as shown in drawing FIG. 33 and also drawing FIG. 40. Accordingly, the switch functions which have been associated with having two conventional mechanical actuator or lever bumper switches and two conventional mechanical actuator or lever trigger switches disposed near and/or on the front side of a conventional game controller as found in the aforementioned game controllers made by Sony® and the Xbox® game controllers made by the Microsoft Corporation can be effectively replaced in by using the four capacitive switches of a single OSEPP capacitive switch module. This can result in cost savings relative to the possible alternative use of four individual Adafruit 1374 capacitive switches or four conventional mechanical actuator or lever switches. Further, capacitive touch switches and/or touch pads can also possibly be used for the left selection control 14, right selection control 15, the action controls 27, and other controls which can be disposed on the top side 23 of a game controller 1 on raised protrusions 85, as shown in drawing FIG. 40, but also for other switches and controls located on the top side 23, bottom side 24, and other sides or surfaces on the exterior side 43 of a game controller 1. These force sensing switches can be used instead and/or as an alternative to the four or more mechanical push button controls, and in particular, the cluster of four push button action controls which are often labeled A, B, X, and Y and found on the top side of conventional game controllers such as the aforementioned game controllers made by Sony® and the Xbox® game controllers made by the Microsoft Corporation. It is possible for capacitive switches to be triggered faster and with less effort relative to conventional mechanical actuator or lever switches and depending upon the video game and player this advantage can possibly be used to enhance the speed and quality of game play, and reduce fatigue of the fingers and hands of an individual player. Further, a game controller 1 can include a sensitivity control within its selection control and/or menu controls in order to customize and regulate the sensitivity of one or more touch pad controls.

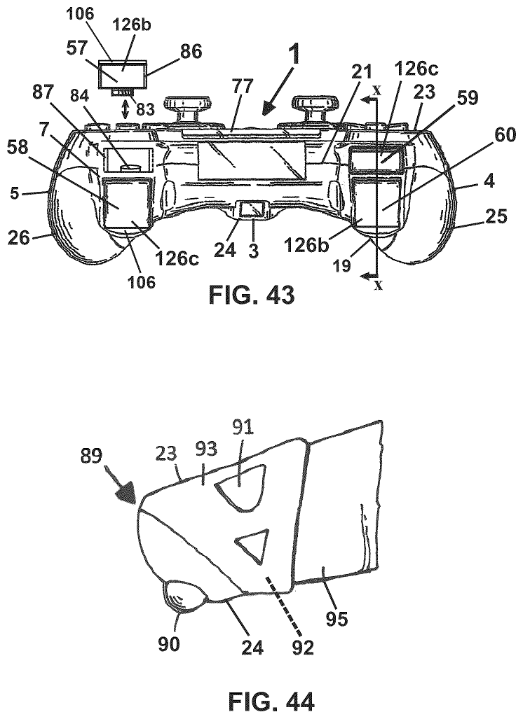

However, depending upon the video game, player, and other circumstances, it can sometimes be advantageous to use force sensing potentiometers also known as electrically resistive pressure sensitive touch controls, switches and/or touch pads for the functions which have been associated with the bumpers and triggers located near or on the front side of conventional game controllers. It is also possible that force sensing potentiometers and capacitive switches could be advantageous for use regarding the functions which have been associated with either the mechanical actuator or lever bumper switches or the mechanical actuator or lever trigger switches often used on conventional game controllers, but not for both of these functions. For example, it is possible that force sensing potentiometers could be more advantageous for use regarding the functions which have been previously associated with the mechanical actuator or lever bumper switches, but not the mechanical actuator or lever trigger switches, or vice-versa, that is, depending on the individual player, video game, and/or other circumstances such as the quality of the computer or game platform being used and/or that of the available internet connection. Accordingly, it could be advantageous to use capacitive controls and switches in combination with electrically resistive pressure sensitive touch controls and switches on a game controller. For this reason, a modular game controller 1 is shown in drawing FIG. 43 which includes a total of four selectively removable modular controls units 126b and 126c disposed near and/or on the front side 21 which can be removably coupled and secured to the case 2 and the required electrical connections so that the specific bumper controls and trigger controls can be selected for use from different possible options and be customized as desired by an individual user or game player.

Moreover, as an alternative to and/or instead of the right joystick which is commonly located on the top side of many conventional game controllers such as the aforementioned game controllers made by Sony® and the Microsoft Corporation, the round, elliptical, or rectangular shaped capacitive modules identified as ProxSense® GPIO Gesture Trackpads made by the Azoteq company of Austin, Texas, can be used on a game controller, as shown in drawing FIG. 38. One example of a capacitive round touch pad made by Azoteq is identified as product TPR 48, and this touch pad and others can be viewed on the company's website www.azoteq.com. A rectangular touch pad and module development tool made by Azoteq that is identified as product IQS550 EV02-S and which includes capacitance touch sensor TPS65-201A-S can be used in conjunction with the programmers processor-based product CT210A-S which can be purchased on the website www.mouser.com, and these components and can then be used with the IQS5XX B000 PC Software that can be downloaded from the Azoteq website www.azoteq.com.

FIG. 30 is bottom view of a game controller 1 according to one embodiment which can include controls and features resembling those shown on the top side 23 and front side 21 of the embodiment shown in FIG. 7, but instead includes on the bottom side 24 a plurality of touch pads 61, 61, 63 on the right handle portion 5 and a plurality of touch pads 66, 67, and 68 on the left handle portion 4 for actuating control of game play. At least two or three separate touch pads can be included on each of the left handle portion 4 and the right handle portion 5, as discussed above in connection with FIG. 29.

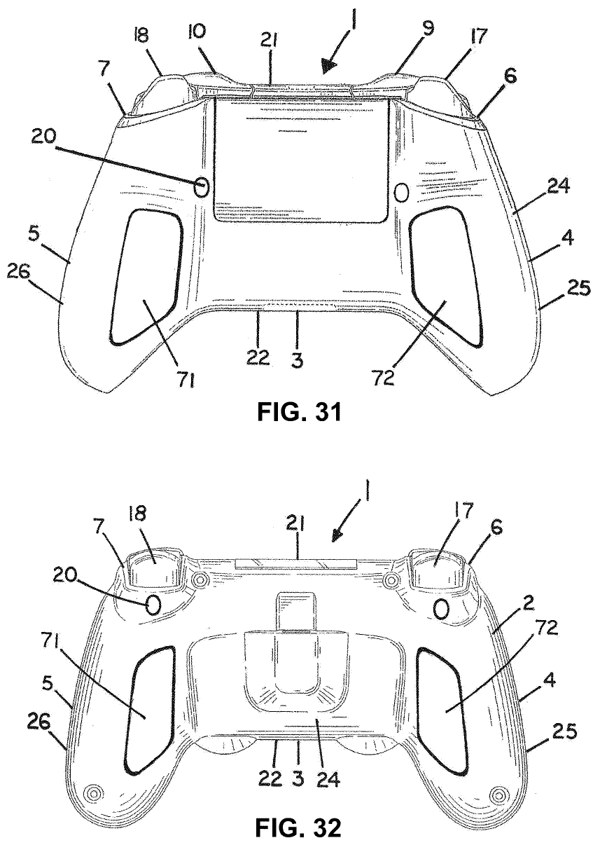

FIG. 31 is a bottom view of a game controller according to one embodiment which can include controls and features resembling those shown on the top side 23 and front side 21 of the embodiment shown in FIG. 1, but which instead includes a single touch pad 71 on the right handle portion 5, and a single touch pad 72 on the left handle portion 4 which each have multi-finger detection and control capability and can be mapped and selected for desired control functions and operations. Once again, U.S. Pat. No. 8,913,019 B2 by Zhao et al. discloses multi-finger detection and control, U.S. Pat. No. 8,982,051 B2 by Rosenfeld et al. discloses a touch pad including multi-finger detection and control on a curved geometric feature; U.S. Pat. No. 9,377,646 B2 by Westues et al. disclosures a touch control including an oblique electrode matrix; U.S. Pat. No. 9,174,124 B2 by Hammontree et al. disclosures touch directional controls having similar function to analog joysticks; and, U.S. Pat. No. 8,581,852 B2 by lzadi et al. and U.S. Pat. No. 8,665,244 B2 by Large et al. disclose structures and methods of optical touch detection and actuation.

FIG. 32 is a bottom view of a game controller according to one embodiment which can include controls and features resembling those shown on the top side 23 and front side 21 of the embodiment shown in FIG. 7, but which instead includes a single touch pad 71 on the right handle portion 5, and a single touch pad 72 on the left handle portion 4 which each have multi-finger detection and control capability and can be mapped and selected for desired control functions and operations, as discussed above in connection with FIG. 31.

FIG. 33 is front view of a game controller 1 according to one embodiment which can include controls and features resembling those shown on the top side 23 of the embodiment shown in FIG. 1, but which instead includes a touch pad 57 and also a touch pad 58 on the right shoulder portion 7, and a touch pad 59 and also a touch pad 60 on the left shoulder portion 6 for actuating control of game play. For example, touch pads 57, 58, 59, and 60 could be force sensing potentiometers also known as pressure sensitive touch switches and/or touch pads which sense force and/or position and use variable resistance induced by the finger pressure of an individual to control movement and/or other action in a video game, as previously discussed herein. Alternatively, touch pads 57, 58, 59, and 60 could be touch switches and/or touch pads which are capacitive instead of pressure sensitive, and which can sense touch and/or position and/or movement as previously discussed herein. Alternatively, touch pads 57, 58, 59, and 60 could include conductive elements 88 which are connected or otherwise in electrical communication with touch switches which are capacitive instead of pressure sensitive, and which can sense touch and/or position and/or movement as previously discussed herein. Alternatively, touch pads 57 and 59 could be touch switches and/or touch pads which are pressure sensing and use variable resistance, and touch pads 58 and 60 could be touch switches and/or touch pads which are capacitive instead of pressure sensitive, and vice-versa, that is, touch pads 57 and 59 could be capacitive and touch pads 58 and 60 could be pressure sensitive.

FIG. 34 is front view of a game controller 1 according to one embodiment which can include controls and features resembling those shown on the top side 23 of the embodiment shown in FIG. 7, but which instead includes a touch pad 57 and also a touch pad 58 on the right shoulder portion 7, and a touch pad 59 and also a touch pad 60 on the left shoulder portion 6 for actuating control of game play. For example, touch pads 57, 58, 59, and 60 could be force sensing potentiometers also known as pressure sensitive touch switches and/or touch pads which sense force and/or position and use variable resistance induced by the finger pressure of an individual to control movement and/or other action in a video game, as previously discussed herein. Alternatively, touch pads 57, 58, 59, and 60 could be touch switches and/or touch pads which are capacitive instead of pressure sensitive, and which can sense touch and/or position and/or movement as previously discussed herein. Alternatively, touch pads 57, 58, 59, and 60 could include conductive elements 88 which are connected or otherwise in electrical communication with touch switches which are capacitive instead of pressure sensitive, and which can sense touch and/or position and/or movement as previously discussed herein. Alternatively, touch pads 57 and 59 could be touch switches and/or touch pads which are pressure sensing and use variable resistance, and touch pads 58 and 60 could be touch switches and/or touch pads which are capacitive instead of pressure sensitive, and vice-versa, that is, touch pads 57 and 59 could be capacitive and touch pads 58 and 60 could be pressure sensitive.

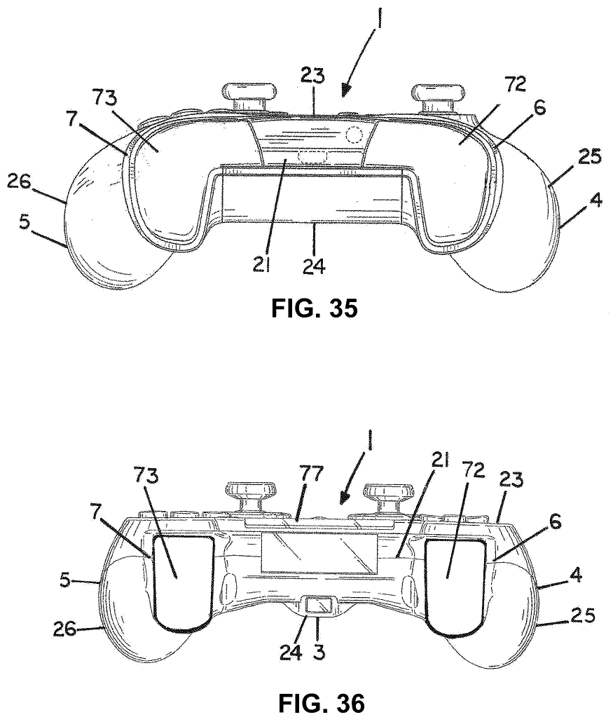

FIG. 35 is front view of a game controller 1 according to one embodiment which can include controls and features resembling those shown on the top side 23 of the embodiment shown in FIG. 1, but which instead includes a single touch pad 73 on the on the right shoulder portion 7, and a single touch pad 72 on the left shoulder portion 6 for actuating control of game play. Each of the touch pads 72 and 73 can have multi-finger detection and control capability and can be mapped and selected for desired control functions and operations.

FIG. 36 is front view of a game controller 1 according to one embodiment which can include controls and features resembling those shown on the top side 23 of the embodiment shown in FIG. 7, but which instead includes a single touch pad 73 on the on the right shoulder portion 7, and a single touch pad 72 on the left shoulder portion 6 for actuating control of game play. Each of the touch pads 72 and 73 can have multi-finger detection and control capability and can be mapped and selected for desired control functions and operations.

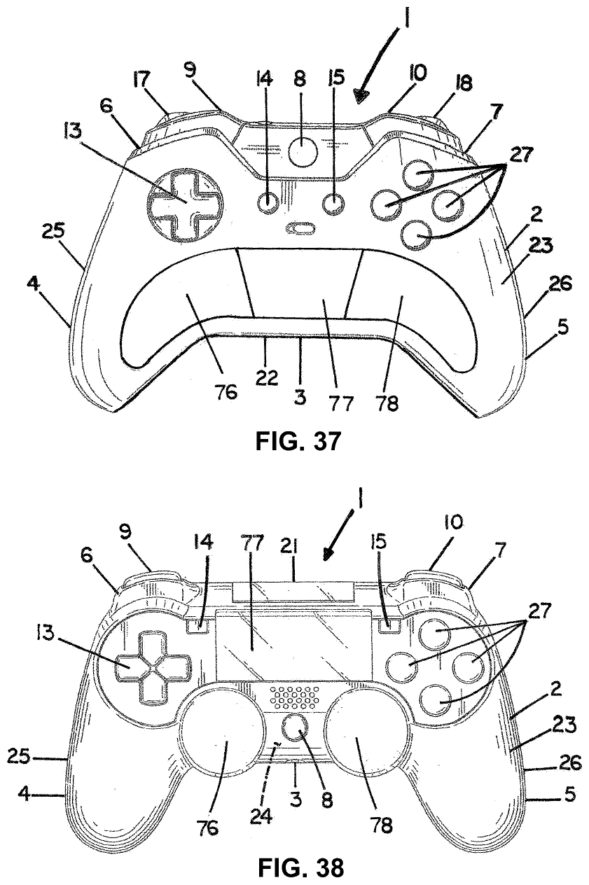

FIG. 37 is top view of a game controller 1 according to one embodiment including a left touch pad 76, a touch control screen 77, and a right touch pad 78 on the top side 23 of the game controller 1. The left touch pad 76 can perform the functions which have been associated with game controllers having a left thumbstick control and/or directional pad control, and right touch pad 78 can perform the functions which have been associated with a right thumbstick control and/or directional pad control. The touch control screen 77 located in the middle portion 3 of the game controller 1 can include a plurality of other menu selections and controls including but not limited to a left selection control, a right selection control, a mapping control, a on and off button, action button controls such as A, B, X, and Y, and then in various possible partial combinations and permutations, or in complete combination, as desired. In an alternative embodiment, the touch control screen 77 can be reduced in size, or alternatively, it can be eliminated so that the left touch pad 76 and right touch pad 78 which can serve as trackpads for use by a user's thumbs can extend more substantially and largely or completely divide the space in middle portion 3 of the game controller 1 on the top side 23 which is show as being occupied by the touch control screen 77.

FIG. 38 is top view of a game controller 1 according to one embodiment including a left touch pad 76, a touch screen 77, and a right touch pad 78 on the top side 23 of the game controller 1. Left touch pad 76 can perform the functions which have been associated with game controllers having a left thumbstick control and/or directional pad control, and right touch pad 78 can perform the functions which have been associated with a right thumbstick control and/or directional pad control. As previously discussed, the left touch pad 76 can be a pressure sensitive touch switch or touch pad which functions using electrical resistance such as the OHMITE round or donut shaped force sensing resistor product identified as FSP03CE, and the like, which can sense both pressure and position. As previously discussed, the right touch pad 78 can include one of the capacitive modules known as the ProxSense® GPIO Gesture Trackpads made by the Azoteq company of Austin, Texas, and the like. The touch screen 77 located in the middle portion 3 of the game controller 1 can include a plurality of other menu selections and controls including but not limited to a left selection control, a right selection control, a mapping control, an on and off button, action button controls such as A, B, X, and Y, and in various possible partial combinations and permutations, or in complete combination, as desired.

FIG. 39 is a top view of a game controller 1 according to one embodiment including a left touch pad 76, a touch screen 77, and a right touch pad 78 on the top side 23 of the game controller 1 as shown in FIG. 37, and a touch pad 57 and also a touch pad 58 on the on the right shoulder portion 7, and a touch pad 59 and also a touch pad 60 on the left shoulder portion 6 as shown in FIG. 33, and on the bottom side 24 at least two of touch pads 61 and 62 on the right handle portion 5 and at least two of touch pads 66 and 67 on the left handle portion 4 for actuating control of game play as shown in FIG. 29. This alternative embodiment of a game controller 1 can provide numerous possible combinations and permutations regarding game controls and mapping options.

FIG. 40 is a top view a game controller 1 according to one embodiment including a left touch pad 76, a touch screen 77, and a right touch pad 78 on the top side 23 of the game controller 1 as shown in FIG. 37, but which further includes a single touch pad 73 and a conductive element 88 on the right shoulder portion 7, and a single touch pad 72 and a conductive element 88 on the left shoulder portion 6 as shown in FIG. 35, and also on the bottom side 24 a single touch pad 71 on the right handle portion 5, and a single touch pad 72 on the left handle portion 4 which each have multi-finger detection and control capability and can be mapped and selected for desired control functions and operations as shown and discussed above in connection with FIG. 31.

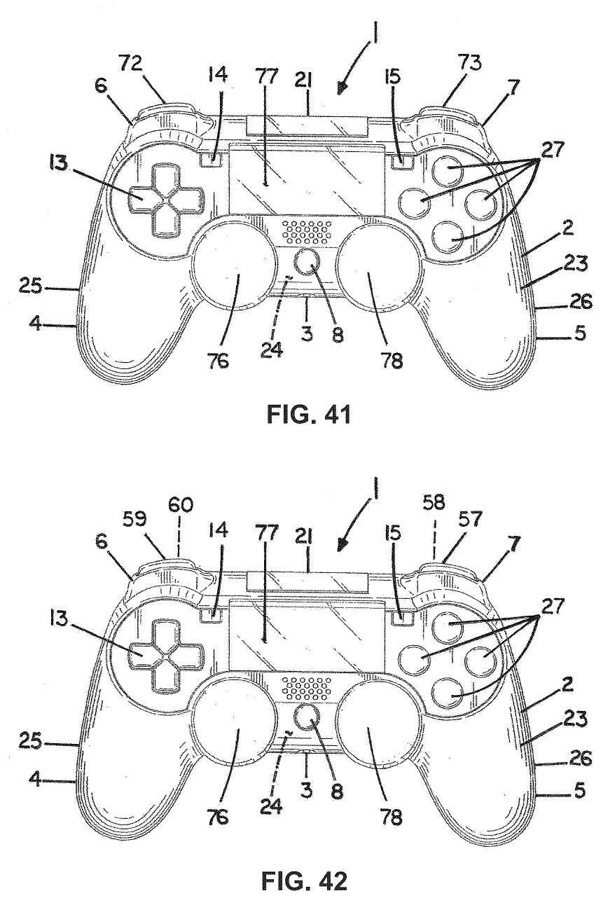

FIG. 41 is a perspective view of a game controller 1 according to one embodiment including a left touch pad 76, a touch screen 77, and a right touch pad 78 on the top side 23 of the game controller 1 similar to that shown in FIG. 38, and further includes a single touch pad 73 on the right shoulder portion 7, and a single touch pad 72 on the left shoulder portion 6 as shown in FIG. 36, and on the bottom side 24 includes a single touch pad 71 on the right handle portion 5, and a single touch pad 72 on the left handle portion 4 as shown in FIG. 32 which each have multi-finger detection and control capability and can be mapped and selected for desired control functions and operations, as shown and discussed above in connection with FIG. 31.

FIG. 42 is a top view of a game controller 1 according to one embodiment including a left touch pad 76, a left directional pad control 13, a touch screen 77, and a right touch pad 78 on the top side 23 of the game controller 1. The left touch pad 76 and/or left directional pad control 13 can be made of a pressure sensitive resistive touch pad like the FSP03CE made by the OHMITE company, and the right touch pad 78 can be made of a capacitive touch pad like the TPR 48 made by the Azoteq company. Other combinations and permutations including pressure sensitive touch switches and/or touch pads can be used. The game controller 1 includes a touch pad 57 and also a touch pad 58 on the right shoulder portion 7, and a touch pad 69 and also a touch pad 70 on the left shoulder portion 6, and the bottom side 24 also includes at least two touch pads 61 and 62 on the right handle portion 5 and at least two of touch pads 66 and 67 on the left handle portion 4 for actuating control of game play. This alternative embodiment of a game controller 1 can also include and provide numerous possible combinations and permutations regarding game controls and mapping options.

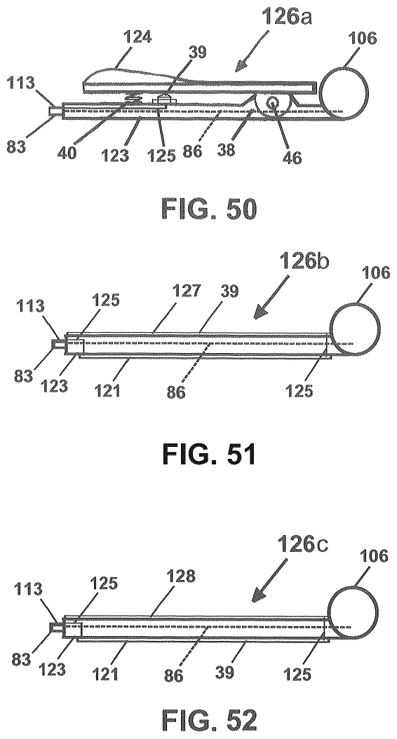

FIG. 43 is front view of a modular game controller 1 according to one embodiment which includes a bumper control 57 and a trigger control 58 on the right shoulder portion 7, and a bumper control 59 and trigger control 60 on the left shoulder portion 6 which can be selected by an individual for use and removably secured in order to customize the structure and performance of the game controller 1. As illustrated with the use of an action arrow positioned between the bumper control 57 and control module 126b shown on the upper left side of drawing FIG. 43, the bumper controls 57 and 59 and their associated control modules 126b and 126c can be removed by a user when desired by pulling and sliding them upwards along a vertical or X axis, and then be replaced by inserting and sliding their replacements downwards along the same axis. The trigger controls 58 and 60 and their associated control modules 126c and 126b can also be removed by a user when desired by pulling and sliding them downwards along a vertical or X axis, and then be replaced by inserting and sliding their replacements upwards along the same axis. The bumper controls 57 and 59 and trigger controls 58 and 60 and case 2 can include tongue structures 86 and/or groove structures 87, and/or snap fit structures, and/or other mechanically mating structures which permit the bumper controls 57 and 59 and their control modules 126b and 126c and also the trigger controls 58 and 60 and their control modules 126c and 126b to be inserted and/or slide into place using mating tongue structures 86 and groove structures 87, and then be removably secured in functional relation to the game controller 1. For example, as shown on the left side of drawing FIG. 43, the bumper control 57 and control module 126b is shown removed from its location on the front side 21 of the case 2 of the game controller 1. This bumper control 57 and control module 126b includes tongue structures 86 on both of its left and right sides for mating with corresponding groove structures 87 which are included in the case 2 for receiving these tongue structures 86 and permitting the bumper control 57 and control module 126b to be removably secured. The bumper control 57 and control module 126b also includes a male electrical connector 83 which can mate with a corresponding female electrical connector 84 which is coupled to and/or is part of the case 2 of the game controller 1, that is, when the bumper control 57 and control module 126b is inserted and/or slid into place and removably secured to the case 2 of the game controller 1. Accordingly, the bumper controls 57 and 59 and the trigger controls 58 and 60 can be selected, changed, and customized by an individual for game play. For example, bumper controls 57 and 59, and trigger controls 58 and 60 could be force sensing potentiometers also known as electrically resistive pressure sensitive touch controls which sense force and/or position and use variable resistance induced by the finger pressure of an individual to control movement and/or other actions in a video game, as previously discussed herein. Alternatively, bumper controls 57 and 59, and trigger controls 58 and 60 could be capacitive controls which can detect a touch and/or the proximity of a user's finger position and movement as previously discussed herein. Alternatively, the bumper controls 57 and 59 could be electrically resistive pressure sensing touch controls, and the trigger controls 58 and 60 could be capacitive controls, and vice-versa, that is, the bumper controls 57 and 59 could be capacitive controls and trigger controls 58 and 60 could be electrically resistive pressure sensitive touch controls. Accordingly, different bumper controls 57 and 59 and trigger controls 58 and 60 having different sensitivities and trigger thresholds can be selected for use by an individual to customize the structure and performance of the game controller 1. Also shown in FIG. 43 is a vertical line Z-Z which is provided for reference purposes to indicate a vertical axis and also the location of a cross-sectional view which is shown and discussed in drawing FIGS. 50-52. A removable electrically resistive pressure sensitive control module 126b including a bumper control 57 is shown on the left side of the drawing, and another is shown on the right side of the drawing with reference to trigger control 60. A removable capacitive control module 126c including a bumper control 59 is shown on the right side of the drawing and another one including a trigger control 57 is shown on the left side of the drawing in order to illustrate that these two different types of controls can be configured and used individually, and in various combinations and permutations for the bumper controls 57 and 59 and trigger controls 58 and 60.

FIG. 44 is a side view of stylus 89 that is made at least in part of a plastic and/or rubber material for use on one or more of the fingers 95 and/or thumb of an individual with a touch pad and/or touch screen 77 on a computer, pad, or game controller. The stylus 89 has a top side 23 and includes an enclosure 93 made of a plastic and/or rubber material which includes openings 91 and forms a pocket 92 for receiving a finger 95 or thumb of an individual wearer, and also includes a ball 90 that is electrically conductive largely disposed on the bottom side 24.

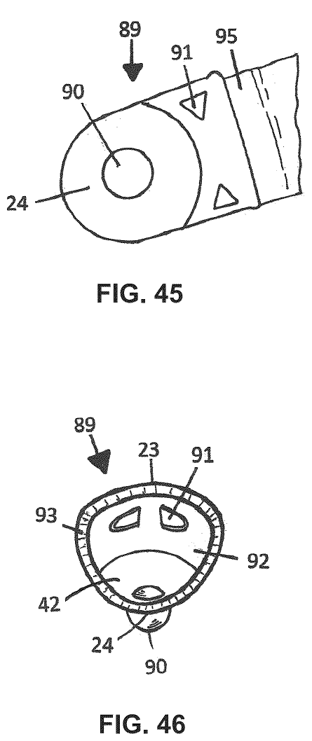

FIG. 45 is a bottom view of the stylus 89 shown in FIG. 44 for use on one or more of the fingers 95 and/or thumb of an individual with a touch pad and/or touch screen 77 on a computer, pad, or game controller. Shown are two openings 90 in the enclosure 93 and an electrically conductive ball 90 that is largely disposed on the bottom side 24 of the stylus 89.

FIG. 46 is an inside view of the stylus 89 shown in FIG. 46 for use on one or more of the fingers 95 and/or thumb of an individual with a touch pad and/or touch screen 77 on a computer, pad, or game controller. The stylus 89 includes an enclosure 93 which forms a pocket 92 for receiving a finger 95 or thumb of an individual wearer and includes a plurality of openings 91 for providing ventilation. As shown, a portion of the ball 90 is exposed and can be seen in the interior side 42 so that it can be placed in electrical communication with a wearer, but also to enhance the tactile and proprioceptive sensitivity and feedback provided to and experienced by an individual during its use and game play.

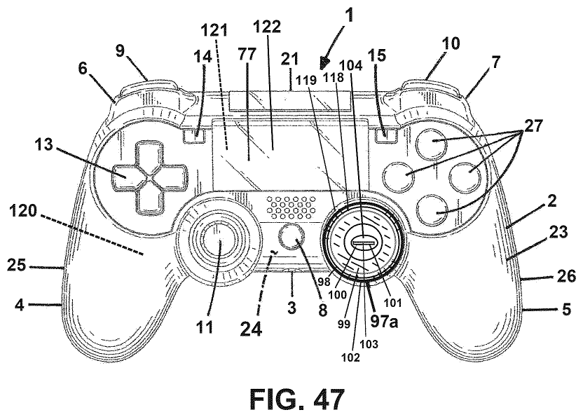

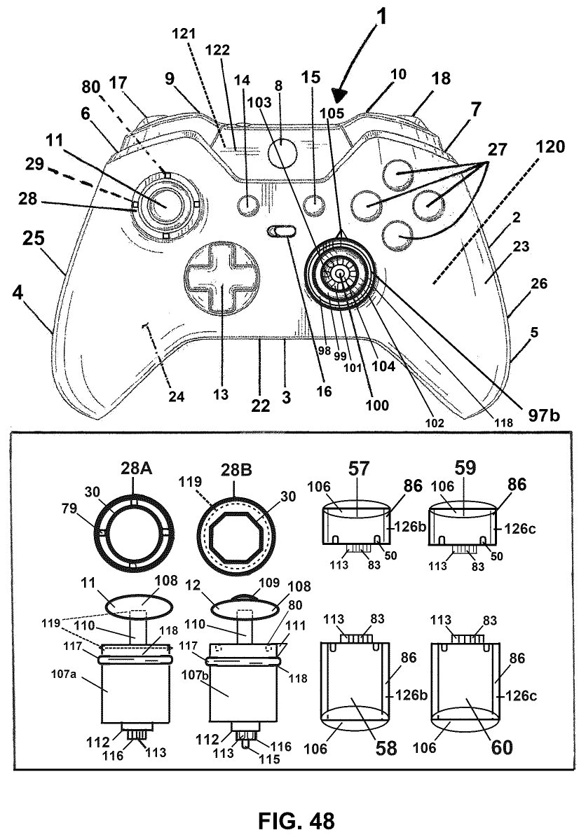

FIG. 47 is a top view of a game controller 1 according to one embodiment having symmetrical placement of removable thumbstick controls 11 and 12 on the top side 23 of the case 2 generally similar to the game controller 1 which is shown in FIG. 7, but showing the right thumbstick control 12 being removed to show one embodiment of a thumbstick receptacle 97a for the right thumbstick control 12 and thumbstick control unit 107a which is shown in a rectangle area near the bottom of FIG. 48. In this regard, the thumbstick receptacle 97a can include in partial or complete combination a rim 102 which can be even with the level of the exterior side 43 of the case 2 near the thumbstick receptacle 97a or alternatively can project above the level of some of the exterior side 43 of the case 2 near the thumbstick receptacle 97a. The thumbstick receptacle 97a can also possibly include male and/or female means for coupling such as male or female threads 119, male snap fit structures 79, or female snap fit structures 80. The thumbstick receptacle 97a can include a side wall 98 which can include an O ring groove 118 for mating with an O ring 117 which is mounted on a removable thumbstick control 107a as shown in FIG. 48, a bottom wall 99, and a female receptacle 100 which can include an electrical insulator 104, and a female electrical port 101 or connection which includes at least one a female electrical contact 103. The electrical port 101 or connection which includes at least one female electrical contact 103 can be generally similar to those typically used on computers and their related plug-in computer wire connections and/or board components, cell phones and their related wires and connectors, and also other electronic devices. Further, the associated wiring and electrical connections can be configured so as to be capable of fast communication speeds such as Firewire® and Thunderbolt® cables and electrical connectors, and/or fiber optic cable and related optical connectors. It can be readily understood that the thumbstick receptacle 97a shown in FIG. 47 could be used in one or both positions for the left and/or right thumbstick(s), or alternatively, that the thumbstick receptacle 97b shown in FIG. 48 could be used in one or both positions for the left and/or right positions for the left and right thumbstick(s) and thumbstick control unit(s) 107b. The thumbstick receptacles 97a and 97b and/or thumbsticks 11 and 12 and/or thumbstick control unit(s) 107a and 107b, and the like, can include at least one tongue structure, at least one groove structure, at least one magnet or magnetic metal structure, at least one male and/or female coupling structure such as complementary male and female thread structures, and/or at least one snap fit structure.

FIG. 48 is a top view of a game controller 1 according to one embodiment having an asymmetrical placement of removable thumbstick controls 11 and 12 on the top side 23 of the case 2 generally similar to the embodiment shown in FIG. 23, but with the right thumbstick control 12 and thumbstick control unit 107b being removed to show one embodiment of a thumbstick receptacle 97b for the thumbstick control unit 107b which is shown in the rectangular area near the bottom of FIG. 48. Also shown in the rectangle area beneath the game controller 1 are alternative embodiments of two removable retaining rings 28A and 28B and/or gates 30 which as discussed elsewhere in this specification can be provided and configured in a plurality of different geometric shapes including but not limited to a circle, an octagon, a square, and/or a diamond shape, and which can be used to customize the play of thumbstick controls 11 and 12. The removable retaining rings 28A and 28B and/or gates 30 can include means for coupling with the top side 23 of the case 2 and/or a portion of the removable thumbstick control units 107a and 107b, e.g., male and female coupling structures such as male snap fit structures 79 and female snap fit structures 80, male and female thread structures 199, and/or magnets 50, and the top side 23 of the case 2 and/or the removable thumbstick control units 107a and 107b can include corresponding mating structures. It can be readily understood that either the male or the female coupling portions can be positioned on the removable thumbstick controls 107a and 107b, the removable rings 28 and/or gates 30, and the game controller 1.

Further, also shown in the rectangle area near the bottom of FIG. 48 are two alternative removable trigger controls 58 and 60, two alternative removable bumper controls 57 and 59, and two alternative removable thumbstick controls 11 and 12 and thumbstick control units 107a and 107b which can be changed and replaced by a user or player as desired and can thereby be used in various partial or complete combination(s) in order to customize the game play of the game controller 1. As shown, a thumbstick control 12 and thumbstick control unit 107b can include a push button control 109 which can be used to select and/or actuate an option, function, or operation during game play, including, but not limited to changing the sensitivity of the thumbstick control 12. The same push button control 109 structure and feature can also be included and used with thumbstick control 107a. The sensitivity of the thumbsticks controls 11 and 12 and associated thumbstick control units 107a and 107b can also be changed as desired using a main menu and/or display 122 which can be made to appear and be manipulated using a touch screen 77 and/or the action keys 27 of the game controller 1.

Accordingly, a user or player can select the type of removable modulate controls 126 they desire for use as trigger controls and/or bumper controls, e.g., they can select a modular control 126a which includes a relatively large mechanical actuator 124 made of thermoplastic which is configured to rotate around a retaining pin 46 which can be in contact a coiled wire return spring 40 and be caused to exert force by a finger of a user on a switch 39, e.g. as shown in FIG. 50, or alternatively a user can select a removable modular control 126b which includes an electrically resistive pressure sensitive touch control 127 which does not include a relatively large mechanical actuator or lever 124 made of thermoplastic, a retaining pin 46, and a coiled wire return spring 40, e.g., the thin or thick film Force Sensing Resistor (FSR) products made by the OHMITE Manufacturing Company of Warrenville, Illinois can be used, and in particular, the products identified as FSR04, FSR05, FSR06, and FSR07 which can be viewed on their website www.ohmite.com, and the like, as shown in FIG. 51, or alternatively a user can select a removable modular control 126c which includes a capacitive control 128 for use as trigger controls and/or bumper controls, e.g., see the capacitive modules such as the ProxSense® GPIO Gesture Trackpads made by the Azoteq company of Austin, Texas, and the like, which also do not require a relatively large mechanical actuator or lever 124 made of thermoplastic, a retaining pin 46, or a coiled wire return spring 40, as shown in FIG. 52, and within these three different types and categories of controllers the user or player can also make further selections from a plurality of different trigger controls and/or bumper controls each having different features and/or performance characteristics.

In this regard, while the general configuration and appearance of the game controllers 1 shown in drawing FIGS. 1-49 and the ergonomics associated with the location and of their trigger controls 58 and 60 and bumper controls 57 and 59 can resemble that of conventional prior art game controllers, the structure of these game controllers and their trigger controls 58 and 60, and/or bumper controls 57 and 59 are different.

FIG. 50 is a side cross-sectional view of a removable control module 126a, as could be taken along a vertical line X-X as shown in FIG. 43, that includes an inside wall 123, a tongue 86 and/or groove 87, a relatively large mechanical actuator or lever 124 for engaging with a finger of a user, a control mount 38, a retaining pin 46, a switch 39, a return spring 40, an electrical wire 125 or electrical conductor, a male electrical connector 83 which includes at least one male electrical contact 113. A control module 126a can be configured for use as one or both the triggers 98 and 100 and/or one or both of the bumpers 97 and 99 of game controller 1. Further, the mechanical actuator or lever 124 can be provided in different configurations and changed by a user as desired. As shown in FIG. 50, a removable mechanical control module 126a can include a mechanical actuator or lever 124 made of thermoplastic which is configured to rotate around a retaining pin 46 retained in a mount 38 and the mechanical actuator or lever 124 can be loaded by a coiled wire return spring 40. A portion of the mechanical actuator or lever 124 can be caused to bear on a switch 39 which is in communication by a wire 125 or other electrical conductor to a male electrical connector 83 which includes at least one male electrical contact 113. The switch 39 can be digital or analog, and if desired can include a hall sensor switch, and/or an electrically resistive switch. Alternatively, the mechanical actuator or lever 124 control module 126a can also further include an integrated circuit 121, as shown in drawing FIGS. 51 and 52. Alternatively, a mechanical actuator or lever 124 control module 126a can include a female electrical connector 84 having at least one female electrical contact 103, and the corresponding and mating male electrical connector 83 including at least one male electrical contact 113 can be associated with the other portion of a mating two-part electrical connector that is connected to a wire 125 or other electrical conductor on or in the case 2 of the game controller 1.

FIG. 51 is a side cross-sectional view of a removable control module 126b, as could be taken along a vertical line X-X as shown in FIG. 43, that includes an inside wall 123, a tongue 86 and/or groove 87, an electrically resistive pressure sensitive touch control 127, an electrical wire 125 or electrical conductor, a male electrical connector 83 which includes at least one male electrical contact 113. A control module 126b can be configured for use as one or both the triggers 98 and 100 and/or one or both of the bumpers 97 and 99 of game controller 1. The electrically resistive touch control 127 can also possibly include an integrated circuit 121 which is configured to be disposed on or in the control module 126, or alternatively, within the interior space 120 defined by the interior side 42 of the case 2 of the game controller 1. Further, the control module 126b can be provided in different configurations and changed by a user as desired. As shown in FIG. 51, the removable electrically resistive touch control module 126b having an electrically resistive pressure sensitive touch control 127 and integral switch 39 for direct contact with a finger of a user does include a large mechanical actuator or lever 124 made of thermoplastic which is configured to rotate around a retaining pin 46 located in a mount 38 and a coiled wire return spring 40. A portion of the user's finger can be caused to bear directly on the electrically resistive pressure sensitive touch control 127 which includes an integral switch 39. In this regard, the electrically resistive touch control 127 and integral switch 39 can be configured to be relatively thin and have a thickness of even less than 1 mm, e.g., see the thin and thick film Force Sensing Resistor products (FSR) made by the OHMITE Manufacturing Company of Warrenville, Illinois which can be used, and in particular, the products identified as FSR04, FSR05, FSR06, and FSR07 which can be viewed on their website www.ohmite.com and purchased online from www.mouser.com. The electrically resistive press sensitive touch control 127 and integral switch 39 can be configured to be placed in electrical communication by a wire 125 or other electrical conductor to a male electrical connector 83 which includes at least one male electrical contact 113. Alternatively, and as shown in FIG. 51, the electrically resistive pressure sensitive touch control 127 and integral switch 39 can first be placed in electrical communication by a wire 125 or other electrical conductor to an integrated circuit 121 which is included in and/or on the control module 126b, and the integrated circuit 121 can then be placed in electrical communicated by a wire 125 or other electrical conductor to a male electrical connector 83 which includes at least one male electrical contract 113. Alternatively, an electrically resistive pressure sensitive touch control module 126b can include a female electrical connector 84 having at least one female electrical contact 103, and the corresponding and mating male electrical connector 83 including at least one male electrical contact 113 can be associated with the other portion of a mating two-part electrical connector that is connected to a wire 125 or other electrical conductor on or in the case 2 of the game controller 1.

FIG. 52 is a side cross-sectional view of a removable control module 126c, as could be taken along a vertical line X-X as shown in FIG. 43, that includes an inside wall 123, a tongue 86 and/or groove 87, a capacitive control 128, an electrical wire 125 or electrical conductor, a male electrical connector 83 which includes at least one male electrical contact 113. A control module 126c can be configured for use as one or both the triggers 98 and 100 and/or one or both of the bumpers 97 and 99 of game controller 1. The capacitive control 128 can also possibly include an integrated circuit 121 which is configured to be disposed on or in the control module 126c, or alternatively, within the interior space 120 defined by the interior side 42 of the case 2 of the game controller 1. Further, the control module 126c can be provided in different configurations and changed by a user as desired. As shown in FIG. 52, the removable control module 126c having a capacitive touch control 128 for direct contact with a finger of a user and/or proximity thereto, does include a large mechanical actuator or lever 124 made of thermoplastic which is configured to rotate around a retaining pin 46 located in a mount 38 and a coiled wire return spring 40. A portion of the user's finger can be caused to touch or be placed in proximity to an electrically conductive surface on the capacitive control 128. The capacitive control 128 can be configured to be placed in electrical communication by a wire 125 or other electrical conductor to a male electrical connector 83 which includes at least one male electrical contact 113, and then to an integrated circuit 121 which includes a switch 39 and/or signal generator contained within the interior space 120 defined by the case 2 of the game controller 1. Alternatively, and as shown in FIG. 52, the capacitive control 128 can first be placed in electrical communication by a wire 125 or other electrical conductor to an integrated circuit 121 which includes a switch 39 and/or signal generator which is included in and/or on the control module 126c, and the integrated circuit 121 and switch 39 and/or signal generator can then be placed in electrical communicated by a wire 125 or other electrical conductor to a male electrical connector 83 which includes at least one male electrical contract 113. Alternatively, the control module 126c can include a female electrical connector 84 having at least one female electrical contact 103, and the corresponding and mating male electrical connector 83 including at least one male electrical contact 113 can be associated with the other portion of a mating two-part electrical connector that is connected to a wire 125 or other electrical conductor on or in the case 2 of the game controller 1.

The removable capacitive controls 128 for use as trigger controls 58 and 60 and/or bumper controls 57 and 59 can include an electrically conductive metal or other electrically conductive material such as carbon fiber, and/or an electrically conductive paint or coating, and be connected by at least one wire 125 or other electrical conductor to at least one integrated circuit 121, and/or to the main menu display 122 and/or touch screen 77 and/or action keys 27 of the game controller 1. The electrically conductive material could hypothetically be a single atom or only several molecules in thickness, and can easily be less than 1-2 mm in thickness. Accordingly, some or all of the electronic components associated with the capacitive controls 128 for use as trigger controls 58 and 60 and/or bumper controls 57 and 59 can also be disposed on and/or in the capacitive controls 128, and these could include at least one integrated circuit 121 and/or computer processor or chip, transistor, resistor, capacitor, diode, inductor, switch, or other electronic components which can be used to select and/or determine the impedance, reactivity, sensitivity, and speed of the trigger control or bumper control. In this regard, the capacitive modules such as the ProxSense® GPIO Gesture Trackpads made by the Azoteq company of Austin, Texas, and the like, are relatively small and can be configured to be located on and/or in the modular and removable capacitive controls 128 for use as trigger controls 58 and 60 and/or bumper controls 57 and 59.

Accordingly, the modular and removable mechanical actuator or lever controls 124, electrically resistive pressure sensitive touch controls 127, capacitive controls 128 for use as trigger controls 58 and 60, and/or bumper controls 57 and 59, but also the thumbstick controls 11 and 12 and thumbstick control units 107a and 107b, can include some or many of the electronic subcomponent parts which are required or associated with their function and use. Alternatively, the modular and removable mechanical actuator or lever controls 124, electrically resistive pressure sensitive controls 127 and capacitive controls 128 for use as trigger controls 58 and 60, and/or bumper controls 57 and 59, but also the thumbstick controls 11 and 12 and thumbstick control units 107a and 107b can possibly include only a few of the electronic subcomponent parts which are required or associated with their function and use, and the remaining electronic subcomponent parts can be included on and/or be in communication with an integrated circuit 121 contained in the interior space 120 defined by the interior side 42 of the case 2 of the game controller 1, and shown using dashed lines in FIGS. 47-49. The integrated circuit 121 can be a part of and/or in electronic communication with a main menu and display 122 which can possibly also include a touch screen 77, and also with action keys 27, and other controls of the game controller 1, and the sensitivity of some or all of the game controls can be adjusted and set according to desire a user or player. It can also be readily understood that the software loaded on a game controller 1, and an associated computer used for gaming, or a game console can be renewed and/or periodically updated using a wire or wireless connection.

The removable control modules 126a, 126b, and 126c which can be used for trigger controls 58 and 60 and/or bumper controls 57 and 59, can include a grip 106 for facilitating their removal and replacement, and can also include at least one tongue 86 and/or at least one groove 87, and at least one male electrical connection 83 including at least one male electrical contact 113 and/or at least one female electrical connection 84 including at least one female electrical contact 103, and can also possibly include at least one magnet 50 for coupling with another magnet 50 or magnetic metal which is disposed on or inside the case 2 of the game controller 1. In this regard, it can be readily understood that the location of the at least one tongue 86 and/or at least one groove 87, and at least one male electrical connection 83 including at least one male electrical contact 113 and/or at least one female electrical connection 84 including at least one female electrical contact 103 can be changed and switched as between the bumper controls 57 and 59 and/or trigger controls 58 and 60, and the interior side 42 or exterior side 23 of the case 2, and vice-versa.

In FIG. 48, on the left side of the rectangular area is shown a thumbstick control unit 107a which can possibly include male or female threads 119 as shown, or alternatively male snap fit 79 or female snap fit 80 structures as shown in thumbstick control unit 107b, or a magnet 50, for coupling or securing a removable retaining ring 28 and/or gate 30 thereto, and/or for securing the thumbstick control units 107a and 107b to the case 2 of the game controller 1. The thumbstick control units 107a and 107b can also include an O ring groove 118 for accommodating a O ring 117 about their circumference which can be mechanically mated to a corresponding O ring groove 118 which is present in the side wall 98 portion of the thumbstick receptacle(s) 97a and 97b, as shown in FIGS. 47 and 48. Thumbstick control unit 107a is configured to mate with the thumbstick receptacle 97a shown in FIG. 47, and includes a male thumbstick projection 112, and a male electrical projection 116 which includes at least one male electrical contact 113, and which typically includes in the range between 2-12 male electrical contacts 113. Alternatively, it can be readily understood that some or all of the male structures shown on the bottom of the thumbstick control 107a can be swapped and changed to the female structures shown in the thumbstick receptacle 97a shown in FIG. 47, and vice-versa. Thumbstick control unit 107b includes a male locating pin 115 for positioning and securing the thumbstick control unit 107b in the female locating pin receptacle 100 that is shown in the receptacle 97b in FIG. 48. Thumbstick control unit 107b is configured to mate with the thumbstick receptacle 97b shown in FIG. 48, and includes a male thumbstick projection 112, and a male electrical projection 116 which includes at least one male electrical contact 113, and which typically includes in the range between 2-12 male electrical contacts 113. Alternatively, it can be readily understood that some or all of the male structures shown on the bottom of the thumbstick control 107b can be swapped and changed to the female structures shown in the thumbstick receptacle 97b shown in FIG. 48, and vice-versa. Thumbstick control unit 107b includes a male locating pin 115 for positioning and securing the thumbstick control unit 107b in the female locating pin receptacle 100 shown in the thumbstick receptacle 97b, and also a male locating projection 111 for mating with the thumbstick position locating notch 105 on the top side 23 of the case 2. Like thumbstick control unit 107a, thumbstick control unit 107b includes a O ring groove 118 for receiving an O ring 117 which can mate with a corresponding O ring groove 118 in the side wall 98 portion of the thumbstick receptacle 97b associated with the top side 23 of the case 2. Other alternative means and structures for removing, replacing, inserting, and securing the thumbstick control units 107a and 107b into corresponding thumbstick receptacles 97a and 97b can be used, including the use of friction fit, mechanical compression fit, male and female coupling structures such as male and female threads, and/or magnets and magnetic metals. It can be readily understood that the thumbstick receptacle 97a shown in FIG. 47 and thumbstick control unit 107a shown in FIG. 48 could be used in both positions for the left and right thumbstick(s) with a game controller 1 having a case 2 which resembles or is like the ones shown in FIG. 47 or FIG. 48. Likewise, it can be readily understood that the thumbstick receptacle 97b shown in FIG. 48 and thumbstick control unit 107b shown in FIG. 48 could be used in both positions for the left and right thumbstick(s) with a game controller 1 having a case 2 which resembles or is like the ones shown in FIG. 47 or FIG. 48. It can also be readily understood that one of each of the thumbstick receptacles 97a and 97b and corresponding thumbstick control units 107a and 107b can be used in the left or right positions with a game controller 1 having a case 2 resembling or like the ones shown in FIGS. 47-48, and that the thumbstick control units 107a and 107b can include hall sensors.

The Sony Dual Sense Edge® which was publicly disclosed on Aug. 23, 2022, and launched globally on Jan. 26, 2023 includes removable thumbstick controls. However, in order to change the thumbstick controls on this product, a removable top cover on the exterior side of the Dual Sense Edge® controller which is a portion of the top side of the case must first be removed, and then the two thumbstick control units can be removed and replaced. A portion of the two thumbstick control units are exposed and extend outwards from the rear side of the Dual Sense Edge® game controller even after the cover portion of the top side of the case of the game controller is installed. Accordingly, Sony provides customers with the ability to renew the set of thumbstick controls of their Dual Sense Edge® product should its thumbstick controls begin to suffer from a drift error or otherwise lose functionality.

In contrast with the Sony Dual Sense Edge® product, the Applicant teaches and shows in FIGS. 47-48 of the present application two alternative embodiments of thumbstick control units 107a and 107b which can be removed from and inserted into corresponding mating thumbstick control receptacles 97a and 97b located on the exterior side 43 and the top side 23 of the case 2 of a game controller 1. Further, a plurality of thumbstick control units 107a and 107b can be configured to provide a range of different performance characteristics, functions, and properties, and thereby enable a user or player to select the ones which they desire in order to customize game play. The thumbstick control units 107a and 107b can be easily and quickly inserted and plugged into corresponding mating thumbstick receptacles 97a and 97b located on the top side 23 of the case 2 and be removed by pulling on the top portion or knob 108 of the thumbstick controls 11 and 12, and/or stem 110, and/or a portion of the thumbstick control unit(s) 107a and 107b. Further, the knob 108 portion of the thumbstick controls 11 and 12 can be removable and retained by friction fit, and/or by mating male and female coupling structures, e.g., male and female threads 119, as shown in FIG. 48. The male locating pin 115 located at the bottom of the thumbstick control unit 107b shown in FIG. 48 can also correspond to a registered opening in the bottom side 24 of the exterior side 43 of the case 2, and a round or octagonal tool having a smaller outside dimension than the opening can then be used to exert force and help remove the thumbstick control unit 107b from a thumbstick receptacle 97b. Further, unlike the Sony Dual Sense Edge® product, a portion of the thumbstick control units 107a and 107b disclosed and shown in FIGS. 47-48 of the present application do not project outwards from and are not exposed on the back side 22 of the game controller 1, but rather are encompassed and surrounded by the upper rim 102 and a portion of the top side 23 of the case 2 of the game controller 1. In addition, the use of O rings 117 and mating O ring grooves 118 on the thumbstick control units 107a and 107b and O ring grooves 118 in the receptacles 97a and 97b which are disposed on the top side 23 of the case 2 can help to secure and stabilize the thumbstick control units 107a and 107b using both friction fit and mechanical compression, but also serve to isolate and seal a substantial portion of the thumbstick control units 107a and 107b, and the like, from the external environment. This can help to prevent dust, dirt, and liquids from getting into the thumbstick control units 107a and 107b, and/or into the interior side 42 of a game controller 1, and thereby potentially serve to enhance their reliability and service life. The thumbstick control units 107a and 107b, and the like, can be configured to have a larger or smaller circular diameter, and alternatively, they can be configured in an oval shape, or other geometric shapes. The thumbstick control units 107a and 107b, and the like, can be removed from and inserted into their corresponding receptacles 97a and 97b, and the like, from the exterior side 43 and top side 23 of the case 2 of the game controller 1 without having to disassemble a portion of the top side 23 of the case 2 in order to gain access to the interior side 42 of the case 2 of game controller 1 and then be able to change the thumbstick control units 107a and 107b. As previously discussed, a retaining ring 28 including a gate 30 can also be selected by a user or player and then be used to customize game play of the thumbstick controls 11 and 12 by limiting and/or facilitating the movement of the knob 108 and/or stem 110 portion of the thumbstick controls 11 and 12 during game play. As shown in FIGS. 47-48, a retaining ring 28 including a gate 30 can be removably secured to a top portion of a thumbstick control unit 107a and 107b and/or to a portion of the top side 23 of the case 2 and then also help to secure a thumbstick control unit 107a and 107b in a corresponding thumbstick control receptacles 97a and 97b of a game controller 1.

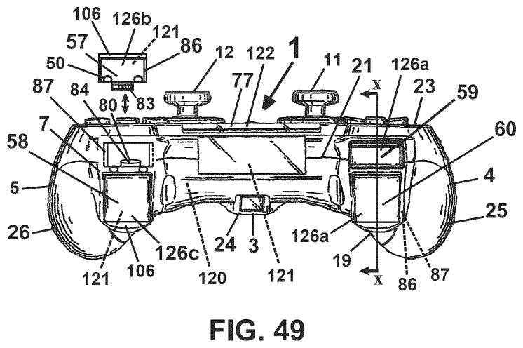

FIG. 49 is front view of a modular game controller 1 according to one embodiment which includes a bumper control 57 and a trigger control 58 on the right shoulder portion 7, and a bumper control 59 and trigger control 60 on the left shoulder portion 6 which can be selected by an individual for use and removably secured in order to customize the structure and performance of the game controller 1. As illustrated with the use of an action arrow positioned between the bumper control 57 and control module 126b shown on the upper left side of drawing FIG. 43, the bumper controls 57 and 59 and their associated control modules 126b and 126a can be removed by a user when desired by pulling and sliding them upwards along a vertical or X axis, and then be replaced by inserting and sliding their replacements downwards along the same axis. The trigger controls 58 and 60 and their associated control modules 126c and 126a can also be removed by a user when desired by pulling and sliding them downwards along a vertical or X axis, and then be replaced by inserting and sliding their replacements upwards along the same axis. The bumper controls 57 and 59 and trigger controls 58 and 60 and case 2 can include tongue structures 86 and/or groove structures 87, and/or snap fit structures, and/or other mechanically mating structures which permit the bumper controls 57 and 59 and their control modules 126b and 126a and also the trigger controls 58 and 60 and their control modules 126c and 126a to be inserted and/or slide into place using mating tongue structures 86 and groove structures 87, and then be removably secured in functional relation to the game controller 1. For example, as shown on the left side of drawing FIG. 43, the bumper control 57 and control module 126b is shown removed from its location on the front side 21 of the case 2 of the game controller 1. This bumper control 57 and control module 126b includes tongue structures 86 on both of its left and right sides for mating with corresponding groove structures 87 which are included in the case 2 for receiving these tongue structures 86 and permitting the bumper control 57 and control module 126b to be removably secured. The bumper control 57 and control module 126b also includes a male electrical connector 83 which can mate with a corresponding female electrical connector 84 which is coupled to and/or is part of the case 2 of the game controller 1, that is, when the bumper control 57 and control module 126b is inserted and/or slid into place and removably secured to the case 2 of the game controller 1. Accordingly, the bumper controls 57 and 59 and the trigger controls 58 and 60 can be selected, changed, and customized by an individual for game play. For example, bumper controls 57 and 59, and trigger controls 58 and 60 can be force sensing potentiometers also known as electrically resistive pressure sensitive touch controls which sense force and/or position and use variable resistance induced by the finger pressure of an individual to control movement and/or other actions in a video game, as previously discussed herein. Alternatively, bumper controls 57 and 59, and trigger controls 58 and 60 can be capacitive controls which can detect a touch and/or the proximity of a user's finger position and movement as previously discussed herein. Alternatively, the bumper controls 57 and 59 could be electrically resistive pressure sensing touch controls, and the trigger controls 58 and 60 could be capacitive controls, and vice-versa, that is, the bumper controls 57 and 59 could be capacitive controls and trigger controls 58 and 60 could be electrically resistive pressure sensitive touch controls. Accordingly, different types of bumper controls 57 and 59 and trigger controls 58 and 60 having different sensitivities and trigger thresholds can be selected for use by an individual to customize the structure and performance of the game controller 1. Also shown in FIG. 49 is a vertical line Z-Z which is provided for reference purposes to indicate a vertical axis and also the location of a cross-sectional view which is shown and discussed in drawing FIGS. 50-52. A removable electrically resistive pressure sensitive touch control module 126b including a bumper control 57, and a removable control module 126c including a capacitive control 58 is shown on the left side of the drawing. Removable modules 126a which include mechanical actuators or levers 124 and coil return springs 40 are shown on the right side of the drawing for the bumper control 59 and also the trigger control 60 in order to help show that different types of control modules 126a, 126b, and 126c can be used in various combinations and permutations for the bumper controls 57 and 59 and trigger controls 58 and 60.

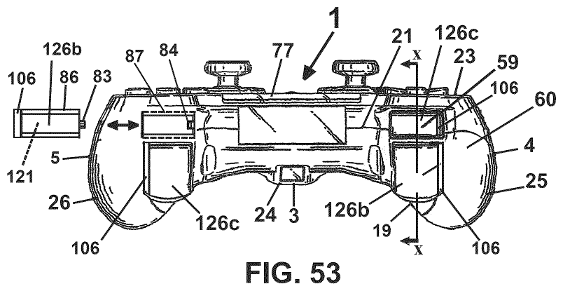

FIG. 53 is a front view of a game controller 1 according to one embodiment which is generally similar to the embodiments shown in FIG. 43 and FIG. 49 having removable bumper controls 57 and 59 and also removable trigger controls 58 and 60. However, as illustrated with the use of an action arrow positioned between the bumper control 57 and its associated control module 126b shown on the upper left side of drawing FIG. 53, the bumper controls 57 and 59 and their associated control modules 126b and 126c can instead be removed by a user when desired by pulling and sliding them out sideways along a horizontal or Y axis, and then be replaced by inserting and sliding their replacement back in sideways along the same axis. The trigger controls 58 and 60 and their associated control modules 126c and 126b can also be removed by a user when desired by pulling and sliding them out sideways along a horizontal or Y axis, and then be replaced by inserting and sliding their replacement in sideways along the same axis. The removable bumper controls 57 and 59, and removable trigger controls 58 and 60 can include in partial or complete combination a tongue 86, a groove 87, at least a portion of a male snap fit connection 79, at least a portion of a corresponding and mating female snap fit connection opening structure 80, and a male electrical connector 83 for mating with a corresponding female electrical connector 84 or alternatively a female electrical connector 84 for mating with a corresponding male electrical connector 83, and can also include at least one magnet 50 or a magnetic metal for engaging with at least one other magnet 50 or magnetic metal disposed on the interior side 42 or exterior side 43 of the case 2. The case 2 of the game controller 1 can include in partial or complete combination a tongue 86, a groove 87, at least a portion of a male snap fit connection 79, at least a portion of a corresponding female snap fit connection 80, a male electrical connector 83 for mating with a corresponding female electrical connector 84, or alternatively, a female electrical connector 84 for mating with a corresponding male electrical connector 83, and can also include at least one magnet 50 or a magnetic metal for engaging with at least one other magnet 50 or magnetic metal disposed on at least one of the removable bumper controls 57 and 59 or removable trigger controls 58 and 60. The bumper control 57 and control module 126b on the right side of the game controller 1 which appears on the left side of this drawing figure is removed to show the various structures which have been discussed above, and it can be readily understood that similar structures are present and shown with the use of dashed lines regarding the other bumper control 59 and the trigger controls 58 and 60. On the left side of drawing FIG. 53, an electrically resistive pressure sensitive touch control module 126b is shown for use as the bumper control 57, whereas a capacitive control module 126c is used for the other bumper control 59. A capacitive control module 126c is also used for the trigger control 58 on the left side of the drawing FIG. 53, whereas an electrically resistive pressure sensitive touch control module 126b is used for the trigger control 60 to illustrate that these three different types of controls can be configured and used in various possible combinations and permutations for the bumper controls 57 and 59 and trigger controls 58 and 60. Moreover, the position of the bumper controls 57 and 59 and trigger controls 58 and 60 can also be changed from top to bottom on the left and right sides, and vice-versa.

It can be readily understood from the disclosure contained in the specification and drawings of this patent application that action buttons or keys 27, left selection control 14, right selection control 15, mapping preset control 16, on/off control 8, directional pad control 13, and other controls can be made using digital switches, or alternatively using analog switches such as electrically resistive force sensitive/pressure sensitive touch controls or switches, and/or capacitive controls or switches. Further, it can be readily understood that selectively removable electrically resistive force sensitive/pressure sensitive touch controls 127 and modules 126b, and capacitive controls 128 and modules 126c, and mechanical actuator or lever controls 124 and modules 126a can be used in various partial or complete combinations. The status and sensitivity of these controls can be seen and adjusted by an individual user as desired with the use of sensitivity controls such as hair trigger lock controls 20, and/or by changing their settings which can be made to appear on the main menu display 122 of a touch screen 77.

It can be readily understood from the disclosure contained in the specification and drawings of this patent application that electrically resistive force sensitive/pressure sensitive touch controls and/or capacitive touch controls can be used in a game controller for the trigger controls and bumper controls instead of conventional mechanical actuator or lever controls. The use of electrically resistive force sensitive touch controls can be advantageous for use on a game controller 1 when the habit or desire of an individual is to keep one or more of their fingers resting on bumper or trigger controls during game play. Accordingly, the use of electrically resistive force sensitive touch controls can then be advantageous for use as the bumper controls and the trigger controls disposed on or proximate the shoulders and the front side of a game controller, e.g., as shown in drawing FIGS. 34 and 42 and indicated by numerals 57, 58, 59, and 60. The force required to trigger an electrically resistive pressure sensitive touch control is typically in the range of between about 10-50 grams per square centimeter, and in particular, the typical range is in the range between about 15-30 grams per square centimeter. The status and sensitivity of these controls or switches can also be set and adjusted by an individual as desired with the use of sensitivity controls such as hair trigger lock controls 20, and/or a settings menu which can be made to appear on the display and/or main menu 122 of a touch screen 77, e.g., as shown in drawing FIG. 42, and/or by an individual user or player making selections and removably replacing controls modules 126a, 126b, and 126c, and the like, as shown and discussed in connection with drawings FIG. 43, and FIGS. 48-52.

It can be readily understood from the disclosure contained in the specification and drawings of this patent application that a single touch pad can register the touch of multiple fingers and that a game controller can be configured and/or programmed to identify the individual finger and/or thumb touches and also link or otherwise associate them with specific desired commands, movements, or other actions when using a game controller. A single touch pad can be electrically resistive and force sensitive and one or more touches be recognized by actual physical contact. Alternatively, a single touch pad can be capacitive and one or more fingers and/or thumbs of an individual can cause desired commands, movements, or other action to be selected by proximate movement or actual physical touches upon a touch pad, or an electrically conductive portion of the case of a game controller. Alternatively, a single touch pad can be optical and one or more fingers and/or thumbs of an individual can cause desired commands, movements, or other actions to be selected by proximate movements or actual physical touches upon a touch pad, or portion of the case of a game controller.

It can be readily understood from the disclosure contained in the specification and drawings of this patent application that electrically resistive force sensitive touch controls and/or capacitive touch controls, and/or mechanical actuator or lever controls can be used on the bottom side 24 of a game controller 1.

It can be readily understood from the disclosure contained in the specification and drawings of this patent application that the left joystick or thumbstick control 11 and/or right joystick and thumbstick control 12 which are often found and used on conventional game controllers can be partially or completely omitted in making a game controller, and instead one or more electrically resistive force sensitive touch pads and/or capacitive touch pads can be disposed and used on the top side 23 of a game controller, and the status and sensitivity of such touch pads can be set and adjusted by an individual as desired with the use of a settings menu which can be made to appear on a touch screen 77. Further, the speed and/or accuracy of an individual's desired selections, movements, and actions in game play when using one or more touch pads disposed on the top side 23 of a game controller 1 can possibly be enhanced and improved with the use of a stylus 89 which can be worn on one or more of the individual's fingers and/or thumbs, as discussed and shown in drawing FIGS. 44-46.

Many other possible combinations and permutations of the structures and features which are shown and disclosed in the present application and also in the patents and patent applications which have been incorporated by reference herein are possible.

The game controllers may be coupled to a games console, computer, or gaming platform by a wire cable and connection, a fiber optical cable and connection, or by a wireless connection device. Further the game controllers may be coupled to a gaming platform online using the Internet by a wire connection, a fiber optical cable connection, or by a wireless connection device.

This disclosure may find application outside of game controllers, and may be applied to the mode of operation of other devices.

It can be readily understood that as used herein, structural, spatial, directional and other references with respect to a game controller such as “top side,” “bottom side,” “front side,” “rear side,” “left side,” “right side,” “interior side,” and “exterior side” do not necessarily limit the respective features to such orientation, but merely serve to distinguish these features from one another. Further, it can be readily understood that reference to the left, right, top, and bottom sides can be used to indicate the location of corresponding surfaces on the exterior side of a game controller.

The following Clauses provide exemplary configurations for a game controller described above and/or methods of making and operating a game controller.

Clause 1: A game controller comprising: a case comprising an interior side, and an exterior side, said exterior side comprising at least one thumbstick control receptacle; and, at least one thumbstick control configured to be removed from and placed in said thumbstick control receptacle.

Clause 2: The game controller according to Clause 1, further comprising at least one trigger control.

Clause 3: The game controller according to Clause 1, further comprising at least one bumper control.

Clause 4: The game controller according to Clause 2, wherein said at least one trigger control comprises at least one electrically resistive pressure sensitive touch control and/or at least one capacitive control.

Clause 5: The game controller according to Clause 3, wherein said at least one bumper control comprises at least one electrically resistive pressure sensitive touch control and/or at least one capacitive control.

Clause 6: The game controller according to Clause 2, said exterior side further comprising at least one trigger control receptacle, said at least one trigger control being configured to be removed from and replaced in said at least one trigger control receptacle.

Clause 7: The game controller according to Clause 3, said exterior side further comprising at least one bumper control receptacle, said at least one bumper control being configured to be removed from and replaced in said at least one bumper control receptacle.

Clause 8: The game controller according to Clause 2, wherein said at least one trigger control comprises at least one electrically resistive pressure sensitive touch control, and a range of force required to actuate said at least one electrically resistive pressure sensitive touch control is in the range between 10-50 grams when measured pursuant to ASTM 1578.

Clause 9: The game controller according to Clause 3, wherein said at least one bumper control comprises at least one electrically resistive pressure sensitive touch control, and a range of force required to actuate said at least one electrically resistive pressure sensitive touch control is in the range between 10-50 grams when measured pursuant to ASTM 1578.

Clause 10: The game controller according to Clause 2, further comprising at least one sensitivity control for selectively adjusting the sensitivity of said at least one trigger control.

Clause 11: The game controller according to Clause 3, further comprising at least one sensitivity control for selectively adjusting the sensitivity of said at least one bumper control.

Clause 12: The game controller according to Clause 1, wherein said at least one thumbstick control further comprises a push button control and/or a sensitivity control.

Clause 13: The game controller according to Clause 1, wherein said case and/or said at least one thumbstick control is configured to receive at least one removable gate configured to be positioned about said at least one thumbstick control, and said at least one removable gate is selected from a plurality of removable gates each comprising an opening having a different geometric shape selected from the group consisting of a circular shape, an octagonal shape, a square shape, and a diamond shape.

Clause 14: The game controller according to Clause 1, and further comprising a plurality of other additional controls selected from the group consisting of: an on/off control, a keyboard control, a master control, a menu control, a control remapping control, a camera control, a back control, a chat control, at least one shift control, at least one hair trigger lock control, at least one sensitivity control, at least one cross-shaped directional control, at least one paddle control, at least one push button control, at least one touch screen control, at least one touch pad control, and, at least one action button control.

Clause 15: A game controller according to Clause 1, wherein said exterior side comprises a top side, a bottom side, a front side, a rear side, a left side, a left shoulder portion, a left handle portion, a right side, a right shoulder portion, a right handle portion, and a middle portion.

Clause 16: The game controller according to Clause 2, wherein said at least one trigger control comprises a capacitive control and a distance required to actuate said at least one trigger control is in the range between 0 and ¼ inch from said at least one trigger control.

Clause 17: The game controller according to Clause 3, wherein said at least one bumper control comprises a capacitive control and a distance required to actuate said at least one bumper control is in the range between 0 and ¼ inch from said at least one bumper control.

Clause 18: The game controller according to Clause 1, wherein said at least one thumbstick receptacle and/or said at least one thumbstick control comprise at least one of a tongue, a groove, an 0 ring groove, an 0 ring, a magnet or magnetic metal, and a snap fit structure.

Clause 19: A game controller comprising: a case comprising an interior side and an exterior side; said exterior side comprising at least one trigger control receptacle, at least one bumper control receptacle, and at least one thumbstick control receptacle; at least one trigger control configured to be removed from and replaced in said at least one trigger control receptacle; at least one bumper control configured to be removed from and replaced in said at least one bumper control receptacle; and, at least one thumbstick control being configured to be removed from and replaced in said at least one thumbstick control receptacle.

Clause 20: A game controller comprising: a case comprising an interior side and an exterior side; said exterior side comprising at least one trigger control receptacle, at least one bumper control receptacle, at least one thumbstick control receptacle, and at least one removable grip receptacle; at least one trigger control configured to be removed from and replaced in said at least one trigger control receptacle, said least one trigger control comprising at least one conventional mechanical actuator or lever switch control, and/or at least one electrically resistive pressure sensitive touch control, and/or at least one capacitive control; at least one bumper control configured to be removed from and replaced in said at least one bumper control receptacle, said at least one bumper control comprising at least one conventional mechanical actuator or lever switch control, and/or at least one electrically resistive pressure sensitive touch control, and/or at least one capacitive control; at least one thumbstick control being configured to be removed from and replaced in said at least one thumbstick control receptacle on said exterior side of said case; at least one sensitivity control for selectively adjusting the sensitivity of at least one of said at least one bumper control, and/or said at least one trigger control, and/or said at least one thumbstick control; at least one removable gate configured to be positioned about said at least one thumbstick control selected from a plurality of removable gates each comprising an opening having a different geometric shape selected from the group consisting of a circular shape, an octagonal shape, a square shape, and a diamond shape; and, at least one removable grip configured to be removed from and replaced in said removable grip receptacle.

While the above detailed description of the invention contains many specificities, these should not be construed as limitations on the scope of the invention, but rather as exemplifications of several preferred embodiments thereof. Although the present invention has been described with reference to preferred embodiments, workers skilled in the art will recognize that changes may be made in form and detail without departing from the spirit and scope of the invention. The disclosed structures and features of a game controller, and also its related functions and methods of play may be combined in various partial or complete combinations and permutations. Accordingly, the scope of the invention should be determined not by the embodiments discussed or illustrated, but by the appended claims and their legal equivalents.

Although the present invention has been described with reference to preferred embodiments, workers skilled in the art will recognize that changes may be made in form and detail without departing from the spirit and scope of the invention.

What is claimed is:

1. A game controller comprising:
a case comprising an interior side, and an exterior side,
said exterior side comprising at least one thumbstick control receptacle; and,
at least one thumbstick control configured to be removed from and placed in said thumbstick control receptacle.

2. The game controller according to claim 1, further comprising at least one trigger control.

3. The game controller according to claim 1, further comprising at least one bumper control.

4. The game controller according to claim 2, wherein said at least one trigger control comprises at least one electrically resistive pressure sensitive touch control and/or at least one capacitive control.

5. The game controller according to claim 3, wherein said at least one bumper control comprises at least one electrically resistive pressure sensitive touch control and/or at least one capacitive control.

6. The game controller according to claim 2, said exterior side further comprising at least one trigger control receptacle, said at least one trigger control being configured to be removed from and replaced in said at least one trigger control receptacle.

7. The game controller according to claim 3, said exterior side further comprising at least one bumper control receptacle, said at least one bumper control being configured to be removed from and replaced in said at least one bumper control receptacle.

8. The game controller according to claim 2, wherein said at least one trigger control comprises at least one electrically resistive pressure sensitive touch control, and a range of force required to actuate said at least one electrically resistive pressure sensitive touch control is in the range between 10-50 grams when measured pursuant to ASTM 1578.

9. The game controller according to claim 3, wherein said at least one bumper control comprises at least one electrically resistive pressure sensitive touch control, and a range of force required to actuate said at least one electrically resistive pressure sensitive touch control is in the range between 10-50 grams when measured pursuant to ASTM 1578.

10. The game controller according to claim 2, further comprising at least one sensitivity control for selectively adjusting the sensitivity of said at least one trigger control.

11. The game controller according to claim 3, further comprising at least one sensitivity control for selectively adjusting the sensitivity of said at least one bumper control.

12. The game controller according to claim 1, wherein said at least one thumbstick control further comprises a push button control and/or a sensitivity control.

13. The game controller according to claim 1, wherein said case and/or said at least one thumbstick control is configured to receive at least one removable gate configured to be positioned about said at least one thumbstick control, and said at least one removable gate is selected from a plurality of removable gates each comprising an opening having a different geometric shape selected from the group consisting of a circular shape, an octagonal shape, a square shape, and a diamond shape.

14. The game controller according to claim 1, and further comprising a plurality of other additional controls selected from the group consisting of: an on/off control, a keyboard control, a master control, a menu control, a control remapping control, a camera control, a back control, a chat control, at least one shift control, at least one hair trigger lock control, at least one sensitivity control, at least one cross-shaped directional control, at least one paddle control, at least one push button control, at least one touch screen control, at least one touch pad control, and, at least one action button control.

15. The game controller according to claim 1, wherein said exterior side comprises a top side, a bottom side, a front side, a rear side, a left side, a left shoulder portion, a left handle portion, a right side, a right shoulder portion, a right handle portion, and a middle portion.

16. The game controller according to claim 2, wherein said at least one trigger control comprises a capacitive control and a distance required to actuate said at least one trigger control is in the range between 0 and ¼ inch from said at least one trigger control.

17. The game controller according to claim 3, wherein said at least one bumper control comprises a capacitive control and a distance required to actuate said at least one bumper control is in the range between 0 and ¼ inch from said at least one bumper control.

18. The game controller according to claim 1, wherein said at least one thumbstick receptacle and/or said at least one thumbstick control comprise at least one of a tongue, a groove, an 0 ring groove, an 0 ring, a magnet or magnetic metal, and a snap fit structure.

19. A game controller comprising:
a case comprising an interior side and an exterior side; said exterior side comprising at least one trigger control receptacle, at least one bumper control receptacle, and at least one thumbstick control receptacle;
at least one trigger control configured to be removed from and replaced in said at least one trigger control receptacle;
at least one bumper control configured to be removed from and replaced in said at least one bumper control receptacle; and,
at least one thumbstick control being configured to be removed from and replaced in said at least one thumbstick control receptacle.

20. A game controller comprising:
a case comprising an interior side and an exterior side;
said exterior side comprising at least one trigger control receptacle, at least one bumper control receptacle, at least one thumbstick control receptacle, and at least one removable grip receptacle;
at least one trigger control configured to be removed from and replaced in said at least one trigger control receptacle, said least one trigger control comprising at least one conventional mechanical actuator or lever switch control, and/or at least one electrically resistive pressure sensitive touch control, and/or at least one capacitive control;
at least one bumper control configured to be removed from and replaced in said at least one bumper control receptacle, said at least one bumper control comprising at least one conventional mechanical actuator or lever switch control, and/or at least one electrically resistive pressure sensitive touch control, and/or at least one capacitive control;
at least one thumbstick control being configured to be removed from and replaced in said at least one thumbstick control receptacle on said exterior side of said case;
at least one sensitivity control for selectively adjusting the sensitivity of at least one of said at least one bumper control, and/or said at least one trigger control, and/or said at least one thumbstick control;
at least one removable gate configured to be positioned about said at least one thumbstick control selected from a plurality of removable gates each comprising an opening having a different geometric shape selected from the group consisting of a circular shape, an octagonal shape, a square shape, and a diamond shape; and,
at least one removable grip configured to be removed from and replaced in said at least one removable grip receptacle.
